(19) United States
(12) Patent Application Publication
(10) Pub. No.: US 2026/0230939 A1
(43) Pub. Date: Aug. 6, 2026

(54) Link Selection During a Roaming Procedure

(71) Applicant: Ofinno, LLC, Reston, VA (US)

(72) Inventors: Tuncer Baykas, Reston, VA (US); Jeongki Kim, Fairfax, VA (US); Esmael Hejazi Dinan, McLean, VA (US); Leonardo Alisasis Lanante, Reston, VA (US); Serhat Erkucuk, Reston, VA (US); Jiayi Zhang, Rockville, MD (US)

(73) Assignee: Ofinno, LLC, Reston, VA (US)

(21) Appl. No.: 19/577,480

(22) Filed: Mar. 25, 2026

Related U.S. Application Data
(63) Continuation of application No. PCT/US2025/030366, filed on May 21, 2025.
(60) Provisional application No. 63/650,980, filed on May 23, 2024.

(51) Int. Cl. H04W 36/00

(52) U.S. Cl. CPC H04W 36/0016; H04W 36/008357

(57) ABSTRACT

A station (STA) multi-link device (MLD) receives from a first access point (AP) MLD a first frame indicating one or more candidate target AP MLDs for a transition by the STA MLD. The STA MLD transmits to the first AP MLD one or more first link reconfiguration request frames indicating one or more second AP MLDs from the one or more candidate target AP MLDs and requesting addition of links between the STA MLD and the one or more second AP MLDs. The STA MLD receives from the first AP MLD one or more link reconfiguration response frames indicating addition of the one or more links between the STA MLD and the one or more second AP MLDs. The STA MLD transmits to a third AP MLD, of the one or more second AP MLDs, a second link reconfiguration request frame requesting transitioning to the third AP MLD.

### CROSS-REFERENCE TO RELATED APPLICATIONS

This application is a continuation of International Application No. PCT/US2025/030366, filed May 21, 2025, which claims the benefit of U.S. Provisional Application No. 63/650,980, filed May 23, 2024, all of which are hereby incorporated by reference in their entireties.

### BRIEF DESCRIPTION OF THE DRAWINGS

Examples of several of the various embodiments of the present disclosure are described herein with reference to the drawings.

FIG. 1 illustrates example wireless communication networks in which embodiments of the present disclosure may be implemented.

FIG. 2 is a block diagram illustrating example implementations of a station (STA) and an access point (AP).

FIG. 3 illustrates an example multi-AP network.

FIG. 4 illustrates Enhanced Distributed Channel Access (EDCA) and Coordinated Orthogonal Frequency Division Multiple Access (COFDMA).

FIG. 5 illustrates an example network that includes a coordinated AP set.

FIG. 6 illustrates an example multi-AP operation procedure.

FIG. 7 illustrates an example multi-AP sounding phase.

FIG. 8 illustrates an example multi-AP downlink data transmission phase.

FIG. 9 illustrates an example multi-AP uplink data transmission phase.

FIG. 10 illustrates an example of a STA roaming from a first AP to a second AP.

FIG. 11 illustrates an example of a transition process without communication between APs.

FIG. 12 illustrates an example of a procedure for session transfer via roaming.

FIG. 13 illustrates an example of a problem that may arise in the procedure of FIG. 12.

FIG. 14 illustrates an example of a roaming procedure according to an embodiment.

FIG. 15 illustrates another example of a roaming procedure according to an embodiment.

FIG. 16 illustrates another example of a roaming procedure according to an embodiment.

FIG. 17 illustrates another example of a roaming procedure according to an embodiment.

FIG. 18 illustrates another example of a roaming procedure according to an embodiment.

FIG. 19 illustrates an example process according to an embodiment.

FIG. 20 illustrates an example process according to an embodiment.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. After reading the description, it will be apparent to one skilled in the relevant art how to implement alternative embodiments. The present embodiments may not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a station, an access point, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, may be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={STA1, STA2} are: {STA1}, {STA2}, and {STA1, STA2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages/frames comprise a plurality of parameters, it implies that a parameter in the plurality of parameters is in at least one of the one or more messages/frames but does not have to be in each of the one or more messages/frames.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

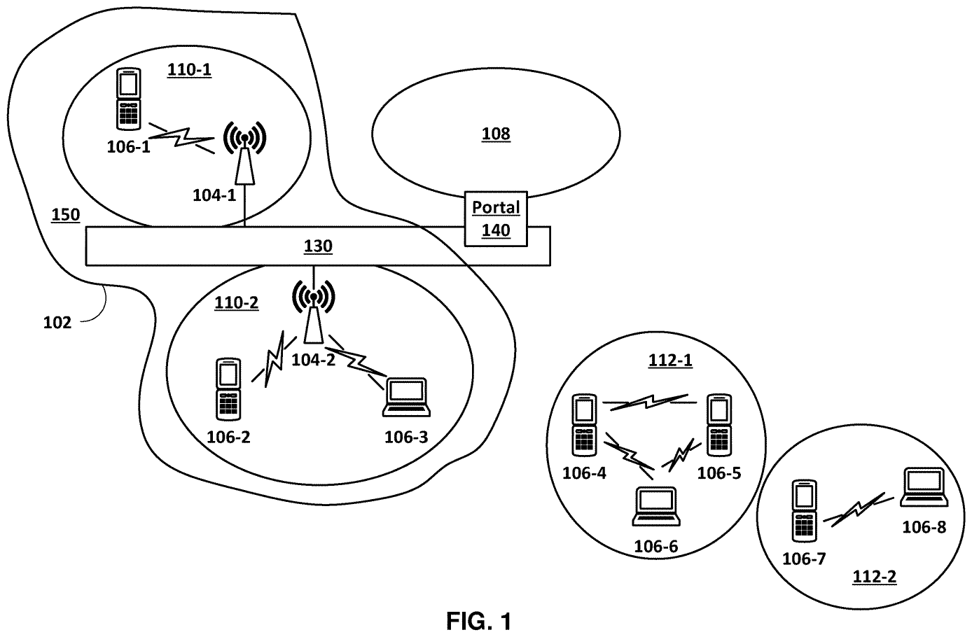

FIG. 1 illustrates example wireless communication networks in which embodiments of the present disclosure may be implemented.

As shown in FIG. 1, the example wireless communication networks may include an Institute of Electrical and Electronic Engineers (IEEE) 802.11 (WLAN) infra-structure network 102. WLAN infra-structure network 102 may include one or more basic service sets (BSSs) 110 and 120 and a distribution system (DS) 130.

BSS 110-1 and 110-2 each includes a set of an access point (AP or AP STA) and at least one station (STA or non-AP STA). For example, BSS 110-1 includes an AP 104-1 and a STA 106-1, and BSS 110-2 includes an AP 104-2 and STAs 106-2 and 106-3. The AP and the at least one STA in a BSS perform an association procedure to communicate with each other.

DS 130 may be configured to connect BSS 110-1 and BSS 110-2. As such, DS 130 may enable an extended service set (ESS) 150. Within ESS 150, APs 104-1 and 104-2 are connected via DS 130 and may have the same service set identification (SSID).

WLAN infra-structure network 102 may be coupled to one or more external networks. For example, as shown in FIG. 1, WLAN infra-structure network 102 may be connected to another network 108 (e.g., 802.X) via a portal 140. Portal 140 may function as a bridge connecting DS 130 of WLAN infra-structure network 102 with the other network 108.

The example wireless communication networks illustrated in FIG. 1 may further include one or more ad-hoc networks or independent BSSs (IBSSs). An ad-hoc network or IBSS is a network that includes a plurality of STAs that are within communication range of each other. The plurality of STAs are configured so that they may communicate with each other using direct peer-to-peer communication (i.e., not via an AP).

For example, in FIG. 1, STAs 106-4, 106-5, and 106-6 may be configured to form a first IBSS 112-1. Similarly, STAs 106-7 and 106-8 may be configured to form a second IBSS 112-2. Since an IBSS does not include an AP, it does not include a centralized management entity. Rather, STAs within an IBSS are managed in a distributed manner. STAs forming an IBSS may be fixed or mobile.

A STA as a predetermined functional medium may include a medium access control (MAC) layer that complies with an IEEE 802.11 standard. A physical layer interface for a radio medium may be used among the APs and the non-AP stations (STAs). The STA may also be referred to using various other terms, including mobile terminal, wireless device, wireless transmit/receive unit (WTRU), user equipment (UE), mobile station (MS), mobile subscriber unit, or user. For example, the term “user” may be used to denote a STA participating in uplink Multi-user Multiple Input, Multiple Output (MU MIMO) and/or uplink Orthogonal Frequency Division Multiple Access (OFDMA) transmission.

A physical layer (PHY) protocol data unit (PPDU) may be a composite structure that includes a PHY preamble and a payload in the form of a PLCP service data unit (PSDU). For example, the PSDU may include a PHY Convergence Protocol (PLCP) preamble and header and/or one or more MAC protocol data units (MPDUs). The information provided in the PHY preamble may be used by a receiving device to decode the subsequent data in the PSDU. In instances in which PPDUs are transmitted over a bonded channel (channel formed through channel bonding), the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

A frequency band may include one or more sub-bands or frequency channels. For example, PPDUs conforming to the IEEE 802.11n, 802.11ac, 802.11ax and/or 802.11be standard amendments may be transmitted over the 2.4 GHz, 5 GHz, and/or 6 GHz bands, each of which may be divided into multiple 20 MHz channels. The PPDUs may be transmitted over a physical channel having a minimum bandwidth of 20 MHz. Larger channels may be formed through channel bonding. For example, PPDUs may be transmitted over physical channels having bandwidths of 40 MHz, 80 MHz, 160 MHz, or 520 MHz by bonding together multiple 20 MHz channels.

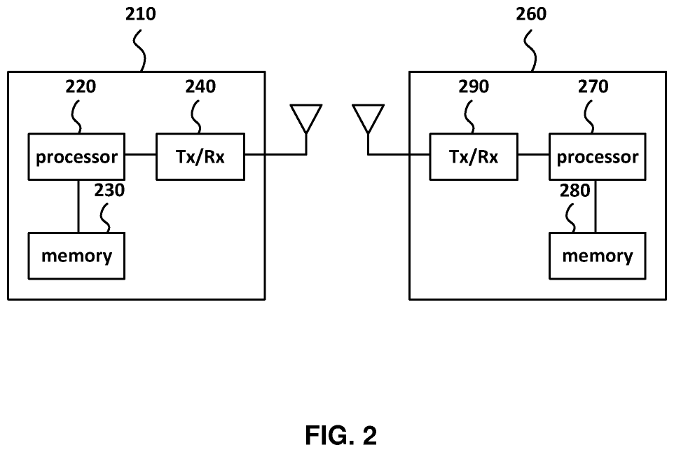

FIG. 2 is a block diagram illustrating example implementations of a STA 210 and an AP 260. As shown in FIG. 2, STA 210 may include at least one processor 220, a memory 230, and at least one transceiver 240. AP 260 may include at least one processor 270, a memory 280, and at least one transceiver 290. Processor 220/270 may be operatively connected to memory 230/280 and/or to transceiver 240/290.

Processor 220/270 may implement functions of the PHY layer, the MAC layer, and/or the logical link control (LLC) layer of the corresponding device (STA 210 or AP 260). Processor 220/270 may include one or more processors and/or one or more controllers. The one or more processors and/or one or more controllers may comprise, for example, a general-purpose processor, a digital signal processor (DSP), a microcontroller, an application specific integrated circuit (ASIC), a field programmable gate array (FPGA), a logic circuit, or a chipset, for example.

Memory 230/280 may include a read-only memory (ROM), a random-access memory (RAM), a flash memory, a memory card, a storage medium, and/or other storage unit. Memory 230/280 may comprise one or more non-transitory computer readable mediums. Memory 230/280 may store computer program instructions or code that may be executed by processor 220/270 to carry out one or more of the operations/embodiments discussed in the present application. Memory 230/280 may be implemented (or positioned) within processor 220/270 or external to processor 220/270. Memory 230/280 may be operatively connected to processor 220/270 via various means known in the art.

Transceiver 240/290 may be configured to transmit/receive radio signals. In an embodiment, transceiver 240/290 may implement a PHY layer of the corresponding device (STA 210 or AP 260). In an embodiment, STA 210 and/or AP 260 may be a multi-link device (MLD), that is a device capable of operating over multiple links as defined by the IEEE 802.11 standard. As such, STA 210 and/or AP 260 may each implement multiple PHY layers. The multiple PHY layers may be implemented using one or more of transceivers 240/290.

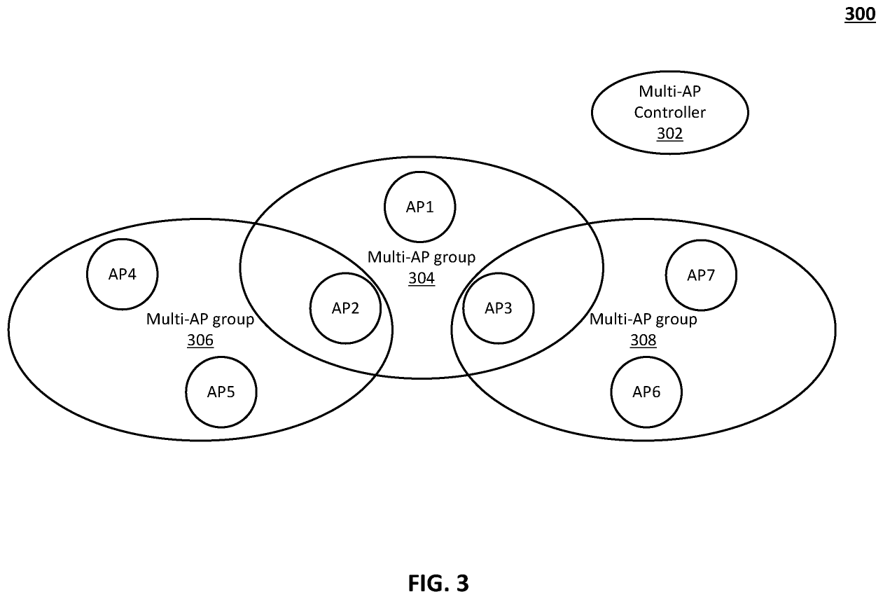

FIG. 3 illustrates an example multi-AP network 300. Example multi-AP network 300 may be a multi-AP network in accordance with the Wi-Fi Alliance standard specification for multi-AP networks. As shown in FIG. 3, multi-AP network 300 may include a multi-AP controller 302 and a plurality of multi-AP groups (or multi-AP sets) 304, 306, and 308.

Multi-AP controller 302 may be a logical entity that implements logic for controlling the APs in multi-AP network 300. Multi-AP controller 302 may receive capability information and measurements from the APs and may trigger AP control commands and operations on the APs. Multi-AP controller 302 may also provide onboarding functionality to onboard and provision APs onto multi-AP network 300.

Multi-AP groups 304, 306, and 308 may each include a plurality of APs. APs in a multi-AP group are in communication range of each other and may coordinate their transmissions and/or transmissions from their associated STAs. Coordinated transmissions may involve all or a subset of the APs in a multi-AP group. A multi-AP group may also be referred to as an AP candidate set as APs in a multi-AP group are considered candidates for a coordinated transmission initiated by an AP. The APs in a multi-AP group are not required to have the same primary channel. As used herein, the primary channel for an AP refers to a default channel that the AP monitors for management frames and/or uses to transmit beacon frames. For a STA associated with an AP, the primary channel refers to the primary channel of the AP, which is advertised through the AP's beacon frames.

In one approach, a multi-AP group may be established by a coordinator AP in a multi-AP setup phase prior to any multi-AP coordination. APs of the multi-AP group, other than the coordinator AP, may be referred to as the coordinated APs. A coordinator AP may establish one or more multi-AP groups. A coordinated AP may likewise be a member of multiple multi-AP groups. A coordinator AP of a multi-AP group may be a coordinated AP of another multi-AP group, and vice versa. In another approach, a multi-AP group may be established by a network administrator manually by configuring APs as part of the multi-AP group. In yet another approach, a multi-AP group may be established in a distributed manner by APs without a central controller. In this case, an AP may advertise its multi-AP capability in a beacon or other management frame (e.g., public action frame). Other APs that receive the frame with the multi-AP capability information may perform a multi-AP setup with the AP that advertised the multi-AP capability.

In one approach, one of the APs in a multi-AP group may be designated as a master AP. The designation of the master AP may be done by AP controller 302 or by the APs of the multi-AP group. The master AP of a multi-AP group may be fixed or may change over time between the APs of the multi-AP group. An AP that is not the master AP of the multi-AP group is known as a slave AP.

In one approach, APs in a multi-AP group may perform coordinated transmissions together. One aspect of coordination may include coordination to perform coordinated transmissions within the multi-AP group. As used herein, a coordinated transmission, also referred to as a multi-AP transmission, is a transmission event in which multiple APs (of a multi-AP group or a multi-AP network) transmit in a coordinated manner over a time period. Coordinated transmissions may involve simultaneous transmissions of a plurality of APs in a multi-AP group. The time period of simultaneous AP transmission may be a continuous period. The multi-AP transmission may use different transmission techniques, such as Coordinated OFDMA (COFDMA), Coordinated Spatial Reuse (CSR), Joint Transmission or Reception (JT/JR), Coordinated Beamforming (CBF), and CTDMA, or a combination of two or more of the aforementioned techniques.

Multi-AP transmissions may be enabled by the AP controller and/or by the master AP of the multi-AP group. In one approach, the AP controller and/or the master AP may control time and/or frequency sharing in a transmission opportunity (TXOP). For example, when one of the APs (e.g., the master AP) in the multi-AP group obtains a TXOP, the AP controller and/or the master AP may control how time/frequency resources of the TXOP are to be shared with other APs of the multi-AP group. In an implementation, the AP of the multi-AP group that obtains a TXOP becomes the master AP of the multi-AP group. The master AP may then share a portion of its obtained TXOP (which may be the entire TXOP) with one or more other APs of the multi-AP group.

Different multi-AP transmission schemes may be suitable for different use cases in terms of privacy protection, including whether transmitted data may be shared with other BSSs in the multi-AP group. For example, some multi-AP transmission schemes, such as CSR, CDTMA, coordinated frequency division multiple access (CFDMA), COFDMA, and CBF, enable a master AP to coordinate slave APs by sharing control information among APs, without requiring the sharing of user data among APs. The control information may include BSS information of APs, link quality information of channels between each AP and its associated STAs, and information related to resources to be used to achieve multiplexing in power, time, frequency, or special domains for multi-AP transmission. The control information exchanged among a master AP and slave APs may be used for interference avoidance or nulling to avoid or null co-channel interference introduced to neighboring BSSs in a multi-AP network. Interference avoidance or interference nulling requires that data transmissions between an AP and STAs are only within the same BSS. In other words, each AP transmits or receives data frames to or from its associated STAs, while each STA receives or transmits data frames to or from its associating AP.

By contrast, other multi-AP transmission schemes may enable a master AP to coordinate slave APs by sharing both control information and user data among APs in a multi-AP group. Control information may include BSS information related to APs and link quality information of channels between each AP and its associated STAs. By having user data exchanged over backhaul, the master AP and slave APs may perform data transmissions jointly to achieve spatial diversity, e.g., using distributed MIMO, for example, joint transmission (JT) for downlink transmissions and joint reception (JR) for uplink transmissions. The data transmissions between APs and STAs may include transmissions within the same BSS and/or across different BSSs. In other words, an AP may transmit or receive data frames to or from its associated STAs as well STAs associated with other APs participating in multi-AP transmission. Similarly, a STA may transmit or receive data frames to or from multiple APs.

Different multi-AP transmission schemes may be suitable for different use cases in terms of signal reception levels at STAs or APs within a multi-AP group. For example, CBF and JT/JR require that each STA involved in a multi-AP transmission be located within a common area of signal coverage of the APs involved in the multi-AP transmission. Generally, CBF may be suitable when a receiving STA suffers from potential interference from other APs in the multi-AP group. By using channel related information such as channel state information (CSI), channel quality indication (CQI), or compressed beamforming (BF) feedback exchanged among APs, an AP may pre-code a signal to be transmitted to form a beam that increases power toward a target STA while reducing the power that interferes with a STA associated with a neighboring AP. Use cases of JT/JR may require a sufficient received signal power at receiving STAs for JT and a sufficient received signal power at receiving APs for JR. By contrast, CSR may perform multi-AP transmission in an interference coordination manner. The received signal power at a STA associated with an AP transmitting data may be required to be much higher than the received interference power.

Different multi-AP transmission schemes may require different synchronization levels and may operate with or without a backhaul between a master AP and slave APs in a multi-AP group. For example, CSR may require PPDU-level synchronization, whereas CBF may require symbol-level synchronization. On the other hand, JT/JR may require tight time/frequency/phase-level synchronization as well as a backhaul for data sharing between APs in the multi-AP group.

Different multi-AP transmission schemes may have different complexity levels with regard to coordination between a master AP and slave APs in a multi-AP group. For example, JT/JR may require very high complexity due to both CSI and user data being shared between APs. CBF may require medium complexity due to the sharing of CSI. CFDMA, COFDMA and CTDMA may require medium or relatively low complexity due to the CSI and time/frequency resources to be shared between APs. CSR may require low complexity as the amount of information related to spatial reuse and traffic that needs to be exchanged between APs may be low.

A multi-AP group may adopt a static multi-AP operation including a static multi-AP transmission scheme. A multi-AP network may also be dynamic due to various reasons. For example, a STA may join or leave the multi-AP network, a STA may switch to a power save mode, or an AP or a STA may change its location. Such changes may lead to changes in the conditions underlying the selection of the multi-AP transmission scheme and may cause certain requirements (e.g., synchronization, backhaul, coordination, etc.) for the multi-AP transmission scheme to be lost. This results in an inferior quality of transmissions in the multi-AP network.

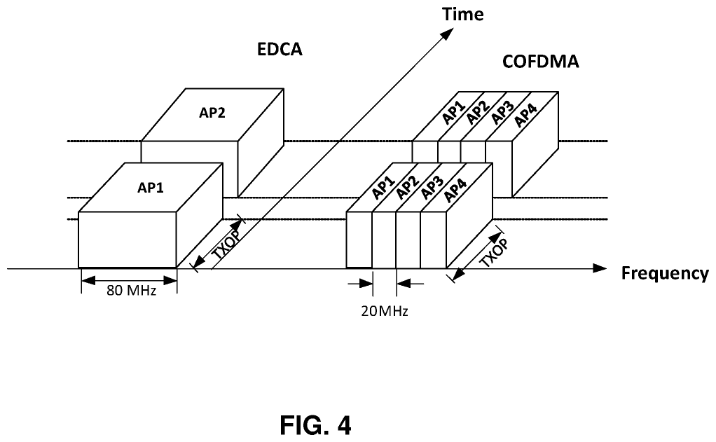

In COFDMA, the master AP may share a portion of its TXOP with multiple APs by assigning each of the multiple APs a respective frequency resource (e.g., channel/subchannel) of available frequency resources. COFDMA is illustrated in FIG. 4 as a multi-AP channel access, compared with Enhanced Distributed Channel Access (EDCA). As shown in FIG. 4, in EDCA, channel access by multiple APs (e.g., AP1, AP2) may occur in consecutive time periods (e.g., TXOPs). During a given channel access, the channel (e.g., 80 MHz) in its entirety may be used by a single AP. In contrast, in COFDMA, access by multiple APs (multi-AP channel access) may take place in a same time period (e.g., same TXOP or same portion of a TXOP) over orthogonal frequency resources. For example, as shown in FIG. 4, an 80 MHz channel may be divided into four non-overlapping 20 MHz channels, each assigned to a respective AP of the multiple APs. The multiple APs may transmit in a coordinated manner, simultaneously in the same time period, to achieve a multi-AP transmission. In the multi-AP transmission, each of the multiple APs may transmit a PPDU to one or more STAs.

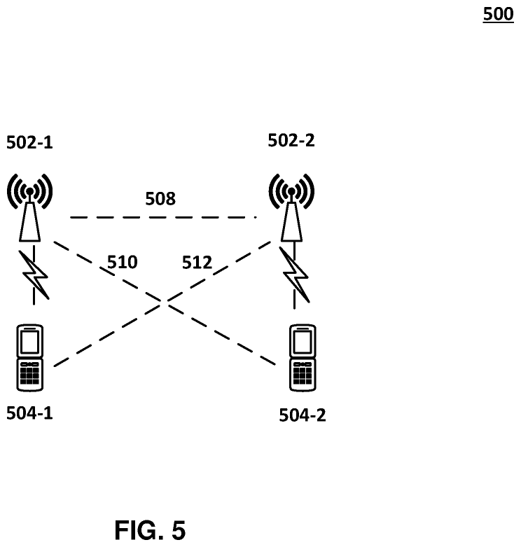

FIG. 5 illustrates an example network 500 that includes a coordinated AP set. As shown in FIG. 5, the coordinated AP set may include two APs - AP 502-1 and AP 502-2. The coordinated AP set may be a subset of an established multi-AP group. At least one STA may be associated with each of APs 502-1 and 502-2. For example, a STA 504-1 may be associated with AP 502-1, and a STA 504-2 may be associated with AP 502-2.

APs 502-1 and 502-2 may belong to the same ESS as described above in FIG. 1. In such a case, APs 502-1 and 502-2 may be connected by a DS to support ESS features. In addition, as part of a coordinated AP set, APs 502-1 and 502-2 may be connected by a backhaul. The backhaul is used to share information quickly between APs to support coordinated transmissions. The shared information may be channel state information or data to be sent to associated STAs. The backhaul may be a wired backhaul or a wireless backhaul. A wired backhaul is preferred for high-capacity information transfer without burdening the main radios of the APs. However, a wired backhaul may require a higher deployment cost and may place greater constraints on AP placement. A wireless backhaul is preferred for its lower deployment cost and flexibility regarding AP placement. However, because a wireless backhaul relies on the main radios of the APs to transfer information, the APs cannot transmit or receive any data while the wireless backhaul is being used.

Typically, one of APs 502-1 and 502-2 may act as a Master AP and the other as a Slave AP. The Master AP is the AP that is the owner of the TXOP. The Master AP shares frequency resources during the TXOP with the Slave AP. When there are more than two APs in the coordinated set, a Master AP may share its TXOP with only a subset of the coordinated AP set. The role of the Master AP may change over time. For example, the Master AP role may be assigned to a specific AP for a duration of time. Similarly, the Slave AP role may be chosen by the Master AP dynamically or can be pre-assigned for a duration of time.

Depending on the capability of APs in a coordinated AP set, the APs may only do certain type of coordinated transmissions. For example, in FIG. 5, if AP 502-1 supports JT and CSR while AP 502-2 supports CSR and CBF, both APs may only perform CSR as a coordinated transmission scheme. An AP may also prefer to perform single AP transmissions for a duration of time if the benefit of coordinated transmission does not outweigh some disadvantages with coordinated transmission such as reduced flexibility and increased computational power required.

CSR is one type of multi-AP coordination that may be supported by AP 501-1 and AP 502-2 as shown in FIG. 5. Spatial reuse using CSR can be more stable than non-AP coordinated spatial reuse schemes such as OBSS PD-based SR and PSR-based SR. For example, in example network 500, APs 502-1 and 502-2 may perform a joint sounding operation in order to measure path loss (PL) on paths of network 500. For example, the joint sounding operation may result in the measurement of PL 508 for the path between APs 502-1 and 502-2, path loss 510 for the path between AP 502-1 and STA 504-2, and path loss 512 for the path between AP 502-2 and STA 504-1. The measured path loss information may then be shared between APs 502-1 and 502-2 (e.g., using the backhaul) to allow for simultaneous transmissions by APs 502-1 and 502-2 to their associated STAs 504-1 and 504-2 respectively. Specifically, one of APs 502-1 and 502-2 obtains a TXOP to become the Master AP. The Master AP may then send a CSR announcement frame to the other AP(s). In an embodiment, the Master AP may perform a polling operation, before sending the CSR announcement frame, to poll Slave APs regarding packet availability for transmission. If at least one Slave AP responds indicating packet availability, the Master AP may proceed with sending the CSR announcement frame. In the CSR announcement, the Master AP may limit the transmit power of a Slave AP in order to protect its own transmission to its target STA. The Slave AP may similarly protect its own transmission to its target STA by choosing a modulation scheme that enables a high enough Signal to Interference Ratio (SIR) margin to support the interference due to the transmission of the Master AP to its target STA.

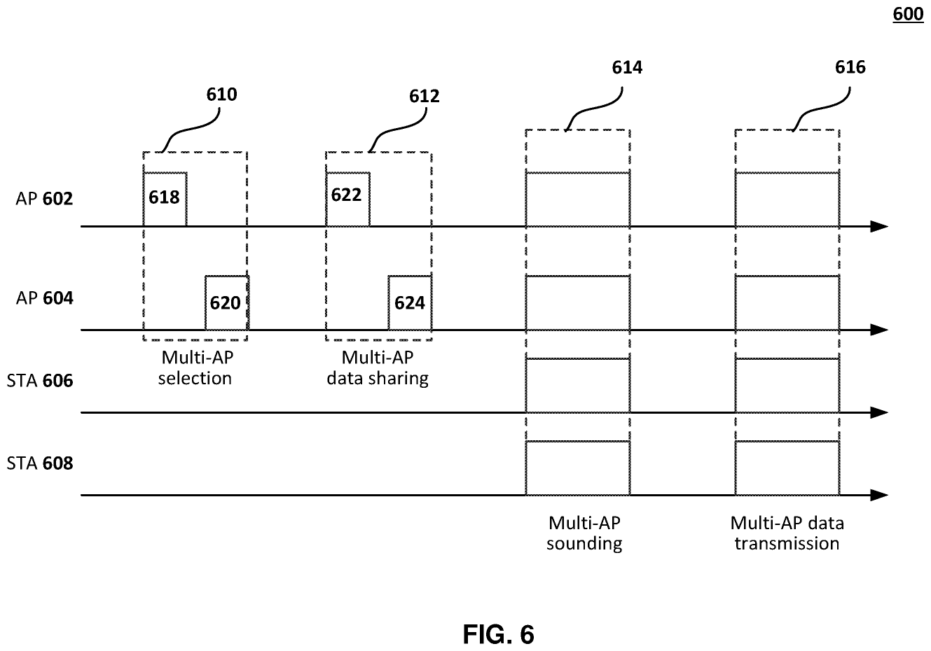

FIG. 6 illustrates an example 600 of a multi-AP operation procedure. In example 600, the multi-AP operation procedure is illustrated with respect to a multi-AP network that includes APs 602 and 604 and STAs 606 and 608. In an example, APs 602 and 604 may form a multi-AP group. AP 602 may be the master AP and AP 604 may be a slave AP of the multi-AP group. For example, AP 602 may obtain a TXOP making it the master AP of the multi-AP group. Alternatively, AP 602 may be designated as the master AP by a multi-AP controller.

As shown in FIG. 6, the multi-AP operation procedure may include a series of phases in time, each of which may contain a plurality of frame exchanges within the multi-AP network. Specifically, the multi-AP operation procedure may include a multi-AP selection phase 610, a multi-AP data sharing phase 612, a multi-AP sounding phase 614, and a multi-AP data transmission phase 616.

A multi-AP network may carry out a multi-AP operation based on a specific multi-AP transmission scheme. The multi-AP transmission scheme may be chosen by the master AP based on the capabilities of the slave APs in a multi-AP group. Prior to a multi-AP operation, a slave AP may inform the master AP of capability information related to the slave AP, including the capabilities of supporting one or more multi-AP transmission schemes. The slave AP may also inform the master AP of BSS information of the BSS of the slave AP and of link quality information for STAs associated with the slave AP. The master AP may receive information related to all available slave APs. The information related to slave APs may include capability information, BSS information, and link quality information. Based on the information provided by available slave APs, the master AP may determine during a multi-AP selection phase the slave APs to be designated for a multi-AP transmission and a specific multi-AP transmission scheme to be used during the multi-AP transmission.

Multi-AP selection phase 610 may include procedures for soliciting, selecting, or designating slave AP(s) for a multi-AP group by a master AP. As seen in FIG. 6, the multi-AP selection phase may include transmissions of frame 618 from AP 602 and frame 620 from AP 604. AP 602 may transmit frame 618 to solicit information regarding the buffer status of AP 604. In response, AP 604 may transmit frame 620 to inform AP 602 of its and its associated STAs buffer status and/or whether it intends to join multi-AP operation. Multi-AP selection phase 610 may also be used to exchange information related to multi-AP operation, including BSS information of APs and link quality information between each AP and its associated STAs, for example. The BSS information of an AP may include a BSS ID of the BSS of the AP, identifiers and/or capabilities of STAs belonging to the BSS, information regarding sounding capabilities of the STAs, information regarding MIMO capabilities of the AP, etc. Link quality information may include received signal strength indicator (RSSI), signal-to-noise ratio (SNR), signal-to-interference-plus-noise-ratio (SINR), channel state information (CSI), channel quality indicator (CQI).

Multi-AP data sharing phase 612 may include procedures for sharing data frames to be transmitted by APs to associated STAs among the master AP and selected slave AP(s) via direct connections between APs. Phase 612 may be optional for some multi-AP data transmission schemes. For example, phase 612 may be required for JT/JR as data frames may be exchanged between APs before or after multi-AP data transmission phase 616.

Multi-AP data sharing phase 612 may be performed using a wired backhaul, an in-channel wireless backhaul, or an off-channel wireless backhaul. In some cases, multi-AP data sharing phase 612 may be performed over an in-channel backhaul, e.g., using the same wireless channel used to transmit/receive data to/from STAs. For example, as shown in FIG. 6, in phase 612, AP 602 may transmit a frame 622, which may be received by AP 604. Frame 622 may include MPDUs that AP 602 wishes to transmit to associated STAs using a multi-AP operation. Similarly, AP 604 may transmit a frame 624, which may be received by AP 602. Frame 624 may include MPDUs that AP 604 wishes to transmit to associated STAs using a multi-AP operation.

Multi-AP sounding phase 614 may include procedures for multi-AP channel sounding, including channel estimation and feedback of channel estimates among the master AP, candidate slave AP(s), and associated STAs. Phase 614 may be optional for some multi-AP transmission schemes, such as COFDMA, CDTMA, and CSR. For example, phase 614 may be performed by the master AP to aid in resource unit allocation when orchestrating a COFDMA transmission.

Multi-AP data transmission phase 616 may include exchange of data frames between the master AP, slave AP(s), and their associated STAs based on multi-AP transmission scheme(s) determined by the master AP. Depending on the multi-AP transmission scheme(s) to be used, phase 616 may include optional synchronization between APs of the multi-AP group, before exchange of data frames between APs and STAs within the multi-AP group.

The order of phases 610, 612, 614 and 616 may be different than shown in FIG. 6. For example, in COFDMA, phase 616 may occur immediately after phase 610, whereas, in JT/JR, phase 612 may occur after phase 610. Further, as mentioned above, some phases may be optional and may or may not be present. For example, phase 614 may not be required for COFDMA but may be required for JT/JR.

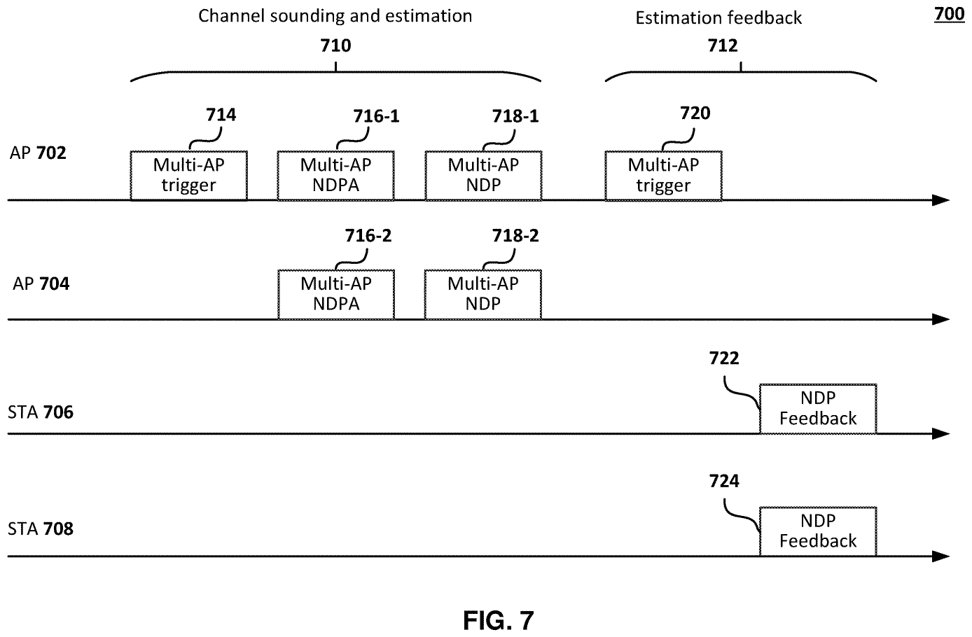

FIG. 7 illustrates an example 700 of a multi-AP sounding phase. Multi-AP sounding phase 700 may be an example of multi-AP sounding phase 614. As shown in FIG. 7, example 700 may include a master AP 702 and a slave AP 704 of a multi-AP group. Example 700 may further include a STA 706 associated with AP 702 and a STA 708 associated with AP 704.

As shown in FIG. 7, multi-AP sounding phase 700 may include frame exchanges to allow AP 702 (the master AP) to acquire channel state information (CSI) of channels in the multi-AP group. In an implementation, phase 700 may include a first subphase 710 and a second subphase 712.

During the first subphase 710, APs may initiate channel sounding and STAs may estimate channel state information (CSI). For example, AP 702 may transmit a frame 714 to AP 704 (the slave AP) to trigger multi-AP sounding. Frame 714 may comprise a multi-AP trigger frame. Subsequently, APs 702 and 704 may transmit respectively announcement frames 716-1 and 716-2 to their respective associated STAs 706 and 708 to announce the transmission of sounding frames. Frames 716-1 and 716-2 may comprise multi-AP null data packet announcement (NDPA) frames. Frames 716-1 and 716-2 may be transmitted simultaneously. Next, APs 702 and 704 may transmit respectively frames 718-1 and 718-2 to STAs 706 and 708 respectively. Frames 718-1 and 718-2 may comprise multi-AP null data packet (NDP) frames. STAs 706 and 708 receive frames 718-1 and 718-2 respectively and perform channel estimation of the channels from AP 702 to STA 706 and from AP 704 to STA 708, respectively.

During the second subphase 712, APs may initiate a procedure for STAs to feed back channel estimates to the APs. For example, AP 702 may transmit a frame 720 to trigger STAs 706 and 708 to transmit their channel estimates to APs 702 and 704 respectively. Frame 720 may comprise a multi-AP trigger frame. In response, STAs 706 and 708 may transmit respectively frames 722 and 724 including feedback of channel estimates to APs 702 and 704 respectively. Frames 722 and 724 may comprise NDP feedback frames. The feedback of channel estimates may include NDP feedback, CSI-related information, a beamforming report (BFR), or a channel quality indication (CQI) report.

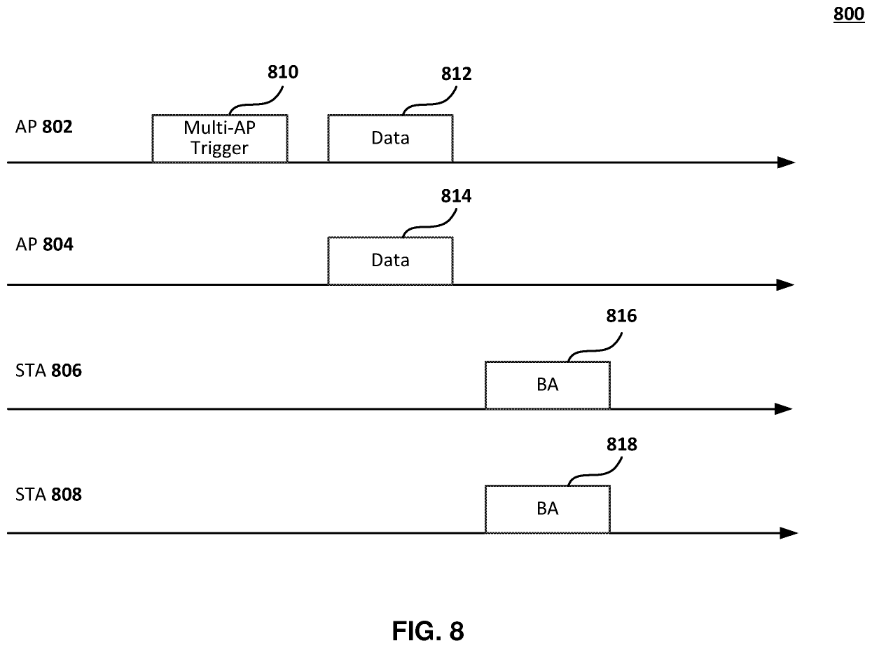

FIG. 8 illustrates an example 800 of a multi-AP downlink data transmission phase. Multi-AP downlink data transmission phase 800 may be an example of multi-AP data transmission phase 616. As shown in FIG. 8, example 800 may include a master AP 802 and a slave AP 804 of a multi-AP group. Example 800 may further include a STA 806 associated with AP 802, and a STA 808 associated with AP 804.

As shown in FIG. 8, multi-AP downlink data transmission phase 800 may include frame exchanges to enable master AP 802 to coordinate with slave AP 804 to perform specific multi-AP transmission schemes with their associated STAs 806 and 808 respectively. The multi-AP transmission schemes may include COFDMA, CTDMA, CSR, CBF, JT/JR, or a combination of two or more of the aforementioned schemes.

As shown in FIG. 8, master AP 802 may begin phase 800 by transmitting a frame 810 to AP 804. Frame 810 may include information related to AP 804 (e.g., an identifier of AP 804), synchronization information, information related to a specific multi-AP transmission scheme to be used, and/or information related to a resource unit (RU) for use by AP 804 to acknowledge frame 810. Frame 810 may comprise a control frame. For example, frame 810 may comprise a multi-AP trigger frame.

Slave AP 804 may receive frame 810 and may use the synchronization information to synchronize with master AP 802. Subsequently, APs 802 and 804 may perform data transmission to their associated STAs 806 and 808 respectively. Specifically, AP 802 may transmit a data frame 812 to its associated STA 806, and AP 804 may transmit a data frame 814 to its associated STA 808. Depending on the multi-AP transmission scheme being used, APs 802 and 804 may transmit frames 812 and 814 respectively to STAs in different BSSs. For example, when the multi-AP transmission scheme is JT/JR, AP 802 may also transmit frame 812 to STA 808 associated with slave AP 804, and AP 804 may also transmit frame 814 to STA 808 associated with AP 804. The resources for transmitting and receiving frames 812 and 814 may depend on the specific multi-AP transmission scheme adopted.

STAs 806 and 808 may acknowledge frames 812 and 814 respectively. For example, STA 806 may transmit a frame 816 to AP 802, and STA 808 may transmit a frame 818 to AP 804. Frames 816 and 818 may comprise block ack (BA) frames. STAs 806 and 808 may also transmit frames 816 and 818 to APs in different BSSs, when required by the used multi-AP transmission scheme. For example, when the multi-AP transmission scheme is JT/JR, STA 806 may also transmit frame 816 to AP 804, and STA 808 may also transmit frame 818 to AP 802. The resources for transmitting and receiving frames 816 and 818 may depend on the specific multi-AP transmission scheme adopted.

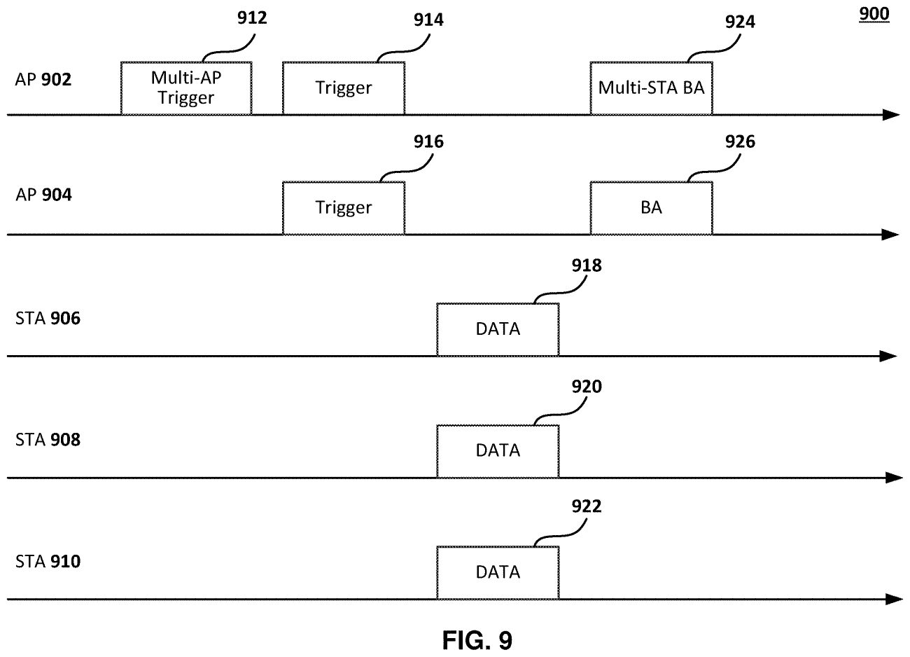

FIG. 9 illustrates an example 900 of a multi-AP uplink data transmission phase. Multi-AP uplink data transmission phase 900 may be an example of multi-AP data transmission phase 616. As shown in FIG. 9, example 900 may include a master AP 902 and a slave AP 904 of a multi-AP group. Example 900 may further include STAs 906 and 908 associated with AP 902, and a STA 910 associated with AP 904.

As shown in FIG. 9, multi-AP uplink data transmission phase 900 may include frame exchanges to enable master AP 902 to coordinate with slave AP 904 to perform specific multi-AP transmission schemes with STAs 906, 908, and 910910. The multi-AP transmission schemes may include COFDMA, CTDMA, CSR, CBF, JT/JR, or a combination of two or more of the aforementioned schemes.

As shown in FIG. 9, master AP 902 may begin phase 900 by transmitting a frame 912 to AP 904. Frame 912 may include information related to AP 904 (e.g., an identifier of AP 904), synchronization information, information related to a specific multi-AP transmission scheme to be used, and/or information related to an RU for use by AP 904 to acknowledge frame 912. Frame 912 may comprise a control frame. For example, frame 912 may comprise a multi-AP trigger frame.

Slave AP 904 may receive frame 912 and may use the synchronization information to synchronize with master AP 902. Subsequently, APs 902 and 904 may solicit uplink data transmissions from their associated STAs 906, 908 and 910 using trigger frames. Specifically, AP 902 may transmit a trigger frame 914 to its associated STAs 906 and 908, and AP 904 may transmit a trigger frame 916 to its associated STA 910. Depending on the multi-AP transmission scheme being used, APs 902 and 904 may also transmit frames 914 and 916 respectively to STAs in different BSSs. For example, when the multi-AP transmission scheme is JT/JR, AP 902 may also transmit frame 914 to STA 910 associated with slave AP 904, and AP 904 may also transmit frame 916 to STAs 906 and 908 associated with AP 902. The resources for transmitting and receiving frames 914 and 916 may depend on the specific multi-AP transmission scheme adopted.

STAs 906 and 908 may respond to frame 914, STA 910 may respond to frame 916. For example, STAs 906 and 908 may transmit frames 918 and 920 respectively to AP 902, while STA 910 may transmit a frame 922 to AP 904. Frames 918, 920, and/or 922 may be transmitted simultaneously. Frames 918, 920, and 922 may comprise data frames or null data frames. STAs 906, 908, and 910 may also transmit frames 918, 920, and 922 respectively to APs in different BSSs, when required by the used multi-AP transmission scheme. For example, when the multi-AP transmission scheme is JT/JR, STAs 906 and 908 may also transmit respective frames 918 and 920 to AP 904, and STA 910 may also transmit frame 922 to AP 902. The resources for transmitting and receiving frames 918, 920, and 922 may depend on the specific multi-AP transmission scheme adopted. AP 902 may acknowledge frames 918 and 920 by transmitting a multi-STA BA frame 924 to STAs 906 and 908. AP 904 may acknowledge frame 922 by transmitting a BA frame 926 to STA 910.

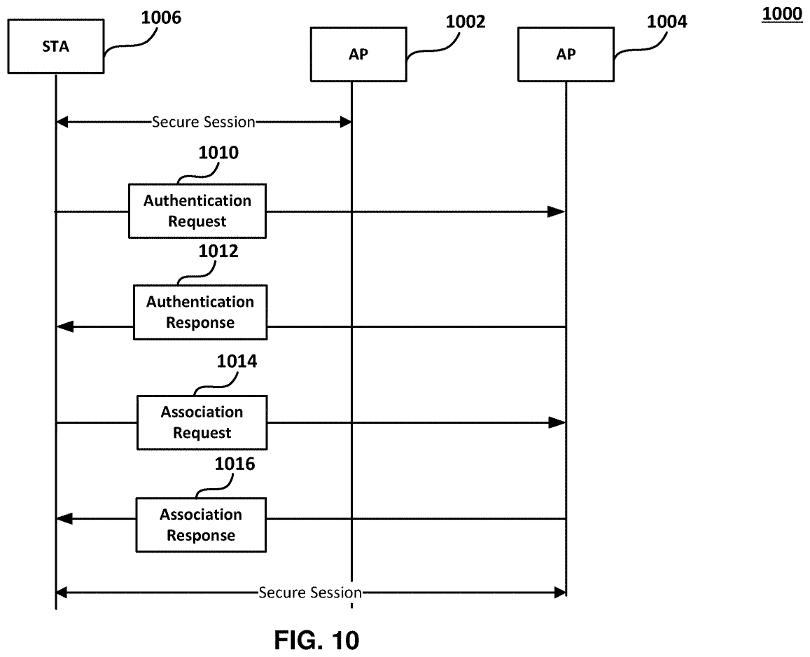

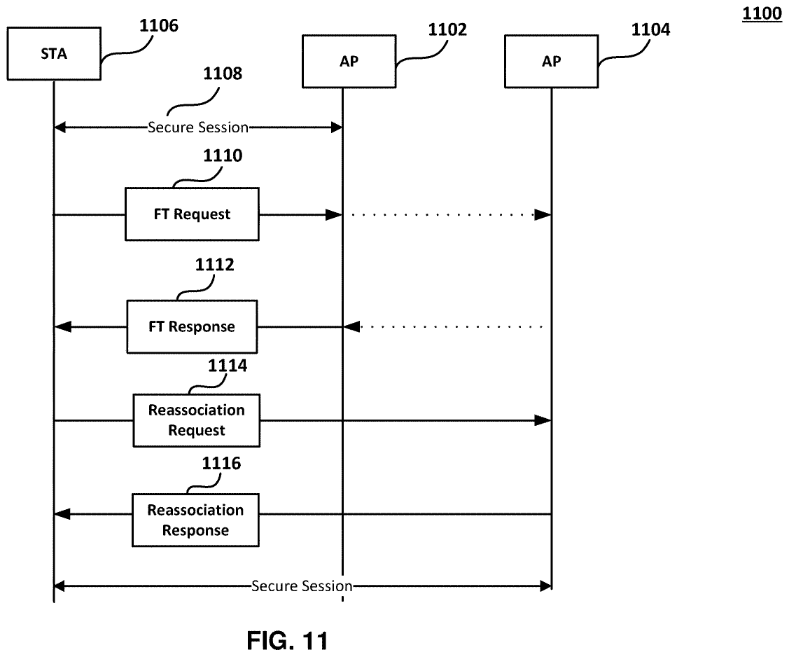

FIG. 10 illustrates an example 1000 of a STA 1006 transitioning/roaming from an AP 1002 to an AP 1004. Before the transitioning/roaming from AP 1002 to AP 1004, STA 1006 may be associated with AP 1002. When STA 1006 moves from within a communication range of AP 1002 to a communication range of AP 1004, a communication session of STA 1006 is transferred from AP 1002 to AP 1004. The IEEE 802.11 standard defines a Basic Service Set (BSS) transition process (described in FIG. 11 below) which may be used to transfer the communication session of STA 1006 from AP 1002 to AP 1004.

STA 1006 starts the transition process by sending an authentication request frame 1010 to AP 1004. IEEE 802.10 authentication operates at the link level between IEEE 802.10 STAs. The IEEE 802.10 standard attempts to control LAN access via the authentication service. IEEE 802.10 authentication is a station service. This service might be used by all STAs to establish their identity to APs with which they communicate. If a mutually acceptable level of authentication has not been established between a STA and an AP, an association is not established.

If AP 1004 accepts authentication request frame 1010, AP 1004 may send an authentication response frame 1012 to STA 1006. Upon reception of authentication response frame 1012, STA 1006 may send an association request frame 1014 to AP 1004, requesting to start a secure session with AP 1004. If AP 1004 accepts the association request of STA 1006, AP 1004 sends an association response frame 1016 to indicate that the secure session is established.

A drawback of the BSS transition process illustrated in FIG. 10 is the duration required to exchange authentication request frame 1010 and authentication response frame 1012. To mitigate this problem, the IEEE 802.10 standard introduced the Fast BSS transition (FT) protocols. The FT protocols seek to reduce the length of time that connectivity is lost between a STA and the distribution system (DS) during a BSS transition. The FT protocols are part of the reassociation service and only apply to STA transitions between APs within the same mobility domain within the same extended service set (ESS). The FT protocols require information to be exchanged during the initial association (or a later reassociation) between a STA (denoted as the FT Originator (FTO)) and an AP. The initial exchange is referred to as the FT initial mobility domain association. Subsequent reassociations to APs within the same mobility domain may make use of the FT protocols.

The IEEE 802.11 standard defines two FT protocols: an FT protocol and an FT resource request protocol. The FT protocol is executed when an FTO makes a transition to a target AP and does not require a resource request prior to the transition. The FT resource request protocol is executed when an FTO requires a resource request prior to the transition. For an FTO to move from its current AP to a target AP utilizing the FT protocols, the message exchanges are performed using one of two methods: Over-the-Air or Over-the-DS. Using the Over-the-Air method, the FTO communicates directly with the target AP using IEEE 802.10 authentication with the FT authentication algorithm. Using the Over-the-DS method, the FTO communicates with the target AP via the current AP.

The communication between the FTO and the target AP is carried in FT Action frames between the FTO and the current AP. Between the current AP and target AP, communication is via an encapsulation. The current AP converts between the two encapsulations. APs advertise both capabilities and policies for supporting the FT protocols and methods.

FIG. 11 illustrates an example of 1100 of the FT protocol using the Over-the-DS method. As shown in FIG. 11, example 1100 may include APs 1102 and AP 1104 and STA 1106. STA 1106 may be associated with AP 1102 at the beginning of example 1100 and may have established a secure session 1108 with AP 1102. APs 1102 and AP 1104 can communicate through the DS. STA 1106 is the FTO. AP 1104 is the Target AP.

The Over-the-DS fast BSS transition may begin with STA 1106 (the FTO) sending an FT request 1110 to AP 1104 (the target AP), via AP 1102. FT request 1110 may include an address (e.g., MAC address) of STA 1106 and an address (e.g., BSSID) of AP 1104. AP 1104 may respond to FT request 1110 by sending an FT response 1112 to STA 1106, via AP 1102. FT response 1112 may include an address of STA 1106, an address of AP 1104, and a status. If STA 1106 does not receive a response to FT request 1110, it may reissue the request following the restrictions given for Authentication frames.

If the status in FT response 1112 indicates SUCCESS, STA 1106 may send a reassociation request frame 1114 to AP 1104. AP 1104 may respond with a reassociation response 1116 to STA 1106.

While the FT protocol eliminates the need for authentication steps, a drawback of the FT protocol is that the FTO and the target AP are still required to perform reassociation steps.

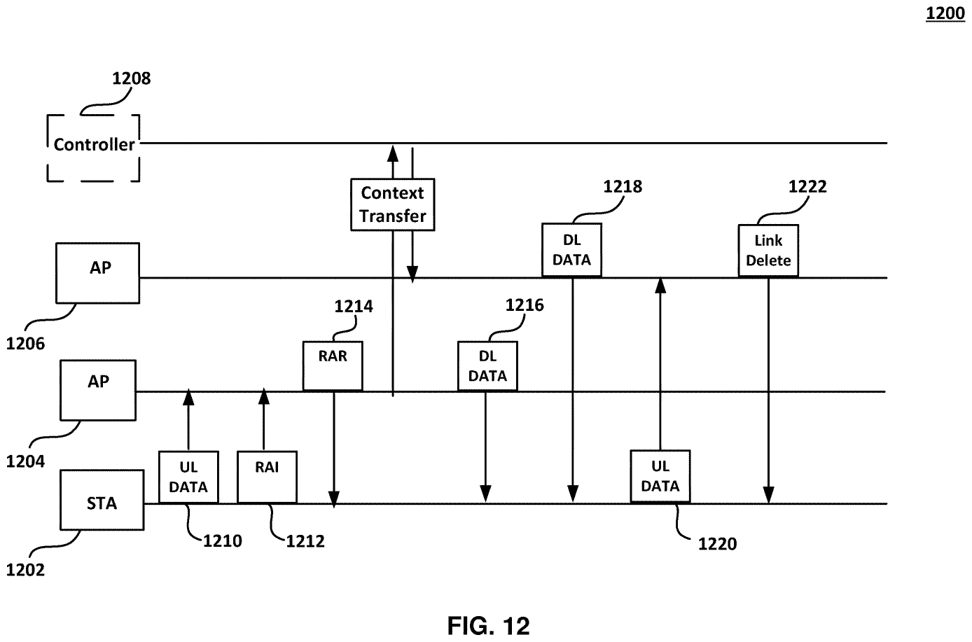

FIG. 12 illustrates an example 1200 of a procedure for session transfer via roaming. As shown in FIG. 12, example 1200 may include a STA 1202, an AP 1204, an AP 1206, and a controller 1208. Controller 1208 may enable communication between AP 1204 and AP 1206. Controller 1208 may be responsible for authentication and association; thus for a session transfer, it may not necessary to repeat the steps of authentication and association.

At the beginning of example 1200, STA 1202 may be associated with AP 1204 and may have established a secure session with AP 1204. To initiate a session transfer from AP 1204 to AP 1206, STA 1202 may send one or more uplink data frames 1210 (including all the buffered uplink data) to AP 1204. Subsequently, STA 1202 may send a roaming announcement indicator (RAI) frame 1212 to AP 1204. RAI frame 1212 may include the address of AP 1206.

On receiving RAI frame 1212, AP 1204 may communicate with controller 1208 to determine if the session transfer is approved. If controller 1208 approves the session transfer, AP 1204 transmits roaming announcement response (RAR) frame 1214 to STA 1202. If controller 1208 approves the session transfer, controller 1208 transfers a context related to STA 1202 from AP 1204 to AP 1206. The context related to STA 1202 may include sequence numbers per traffic identifier for STA 1202. Controller 1208 may also change a data path for data incoming from upper layers from AP 1204 to AP 1206. After transmitting RAR frame 1214, AP 1204 may send one or more downlink data frames 1216 (including all its buffered downlink data for STA 1202) to STA 1202. After AP 1204 sends all data in its buffer for STA 1202, AP 1206 may transmit a link delete frame 1222 to STA 1202 indicating the link between STA 1202 and AP 1204 has been deleted and that STA 1202 may not communicate with AP 1204.

STA 1202 may start communicating with AP 1206 after receiving RAR frame 1214. Specifically, AP 1206 may transfer packets received from upper layers to STA 1202 via one or more downlink data frames 1218. Conversely, STA 1202 may transmit one or more uplink data frames 1220 AP 1206.

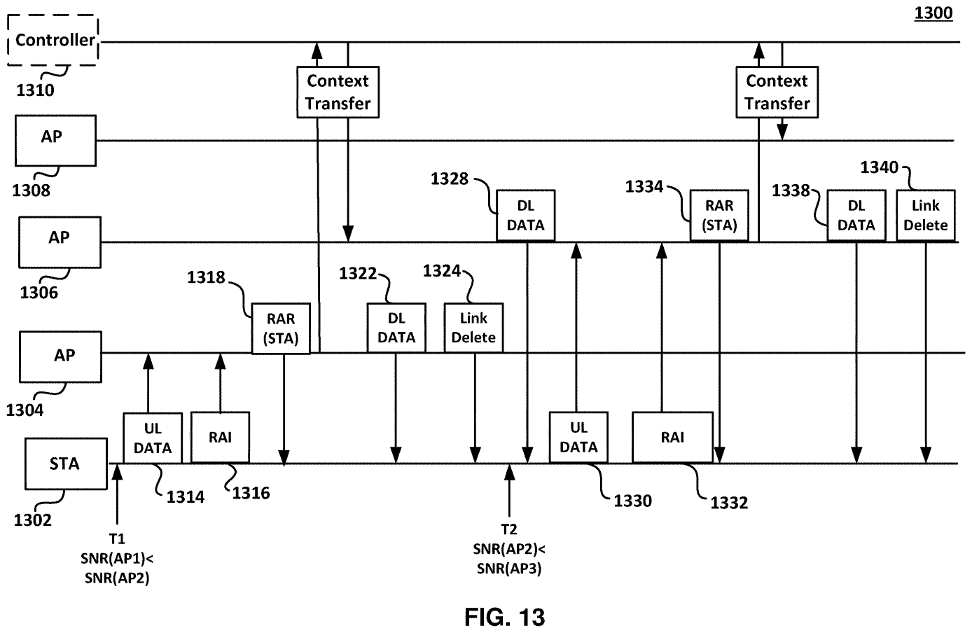

FIG. 13 shows an example 1300 that illustrates a problem that may arise in the procedure of FIG. 12. As shown in FIG. 13, example 1300 includes a STA 1302, APs 1304, 1306, and 1308, and a controller 1310. Controller 1310 may enable communication between AP 1304, AP 1306, and AP 1308. In an implementation, controller 1310 may be connected through a wired link to each of APs 1304, 1306, and 1308 to facilitate communication between APs 1304, 1306, and 1308.

At the beginning of example 1300, STA 1302 may be associated with AP 1304 and may have established a secure session with AP 1304. In an example, at a time T1, STA 1302 may determine that a first link quality of a first link between STA 1302 and AP 1304, with which STA 1302 is associated, is worse than a second link quality of a second link between STA 1302 and AP 1306. For example, a first signal to noise ratio (SNR) measured based on signals received from AP 1304 may be lower than a second SNR measured based on signals received from AP 1306.

Based on determining that the first link quality is worse than the second link quality, STA 1302 may determine to initiate a session transfer from AP 1304 to AP 1306. To initiate the session transfer from AP 1304 to AP 1306, STA 1302 may send one or more uplink data frames 1314 (including all the buffered uplink data) to AP 1304. Subsequently, STA 1302 may send a roaming announcement indicator (RAI) frame 1316 to AP 1304. RAI frame 1316 may include an address of AP 1306.

On receiving RAI frame 1316, AP 1304 may communicate with controller 1310 to determine if the session transfer is approved. If controller 1310 approves the session transfer, AP 1304 transmits roaming announcement response (RAR) frame 1318 to STA 1302. If controller 1310 approves the session transfer, controller 1310 transfers a context related to STA 1302 from AP 1304 to AP 1306. The context related to STA 1302 may include sequence numbers per traffic identifier for STA 1302. Controller 1310 may also change a data path for data incoming from upper layers from AP 1304 to AP 1306. After transmitting RAR frame 1318, AP 1304 may send one or more downlink data frames 1322 (including all its buffered downlink data for STA 1302) to STA 1302. After AP 1304 sends all data in its buffer for STA 1302, AP 1304 may transmit a link delete frame 1324 to STA 1302 indicating the link between STA 1302 and AP 1304 has been deleted and that STA 1302 may not communicate with AP 1304.

STA 1302 may start communicating with AP 1306 after receiving RAR frame 1318. Specifically, AP 1306 may transfer packets received from upper layers to STA 1302 via one or more downlink data frames 1328. Conversely, STA 1302 may transmit one or more uplink data frames 1330 to AP 1306.

In an example, after the link between STA 1302 and AP 1304 has been deleted, at a time T2, STA 1302 may determine that a third link quality of a third link between STA 1302 and AP 1308, with which STA 1302 is not associated, is better than the second link quality of the second link between STA 1302 and AP 1306, with which STA 1302 is now associated. Based on determining that the third link quality is now better than the second link quality, STA 1302 may determine to initiate a session transfer from AP 1306 to AP 1308. As described above and shown in FIG. 13, the session transfer may include STA 1302 transmitting an RAI frame 1332 to AP 1306; AP 1306 transmitting an RAR frame 1334 to STA 1302 if the session transfer is approved; controller 1310 transferring the context related to STA 1302 from AP 1306 to AP 1308; and AP 1306 sending to STA 1302 all its buffered data for STA 1302 followed by a link delete frame 1340 deleting the link between STA 1302 and AP 1306.

In an example, the third link quality of the third link (between STA 1302 and AP 1308) may be better than the second link quality of the second link (between STA 1302 and AP 1306) at time T1. However, as STA 1302 is configured to determine roaming based on comparing the first link quality of the first link (between STA 1302 and AP 1304) with the link quality of only one link, STA 1302 may not select AP 1308 to roam to despite the third link quality of the third link (between STA 1302 and AP 1308) being superior than the second link quality of the second link (between STA 1302 and AP 1306). As a result, STA 1302 may repeat the roaming procedure multiple times until STA 1302 selects to roam to AP 1308 with which STA 1302 has the link with the highest link quality. This may result in STA 1302 initiating multiple successive roaming procedures, causing increased communication overhead, decreased throughput, and increased power consumption at STA 1302 and APs 1304, 1306, and 1308.

Embodiments of the present disclosure, as further described below, address the above-discussed problem. In an aspect, a STA may transmit to a first AP a first frame indicating a roaming procedure. The STA may receive from the first AP a second frame indicating addition of a plurality of links between the STA and a plurality of candidate APs. The STA may transmit to a second AP of the plurality of candidate APs a third frame requesting maintenance of a first link of the plurality of links, where the first link is between the STA and the second AP. The STA may determine the second AP from the plurality of candidate APs based on a respective plurality of frames. Determining the second AP may comprise determining a respective link quality for each link of the plurality of links based on a corresponding frame of the respective plurality of frames. A first link quality of the first link between the STA and the second AP may correspond to a maximum/best link quality among respective link qualities of the plurality of links. The STA may receive from the first AP or the second AP a fourth frame indicating deletion of one or more links of the plurality of links.

In another aspect, a station (STA) multi-link device (MLD) receives from a first access point (AP) MLD a first frame indicating one or more (or a plurality of) candidate target AP MLDs for a transition by the STA MLD. In an embodiment, the first AP MLD is the current AP MLD that the STA MLD is associated with. In an embodiment, the one or more (or plurality of) candidate AP MLDs are recommended by the first AP MLD. In an embodiment, the STA MLD receives the first frame in response to a query to the first AP MLD. The STA MLD transmits to the first AP MLD one or more first link reconfiguration request frames indicating one or more second AP MLDs from the one or more (or plurality of) candidate target AP MLDs and requesting addition of one or more links between the STA MLD and the one or more second AP MLDs. The STA MLD receives from the first AP MLD one or more link reconfiguration response frames indicating addition of the one or more links between the STA MLD and the one or more second AP MLDs. The STA MLD transmits to a third AP MLD, of the one or more second AP MLDs, a second link reconfiguration request frame requesting transitioning to the third AP MLD.

In a further aspect, an AP MLD transmits to a STA MLD, a first frame indicating one or more (or a plurality of) candidate target AP MLDs for a transition by the STA MLD. The AP MLD receives from the STA MLD one or more first link reconfiguration request frames indicating one or more second AP MLDs from the one or more (or plurality of) candidate target AP MLDs and requesting addition of one or more links between the STA MLD and the one or more second AP MLDs. Based on acceptance of addition of the one or more links by the one or more second AP MLDs, the AP MLD transmits to the STA MLD, one or more link reconfiguration response frames indicating the addition of one or more links between the STA MLD and the one or more second AP MLDs; and transfers to the one or more second AP MLDs, context related to the STA MLD. In an embodiment, the AP MLD receives from the STA MLD a second frame requesting a recommendation of candidate target AP MLDs. The AP MLD transmits the first frame in response to the second frame. In an embodiment, the AP MLD receives from the STA MLD a second link reconfiguration request frame requesting transitioning to a third AP MLD of the one or more second AP MLDs.

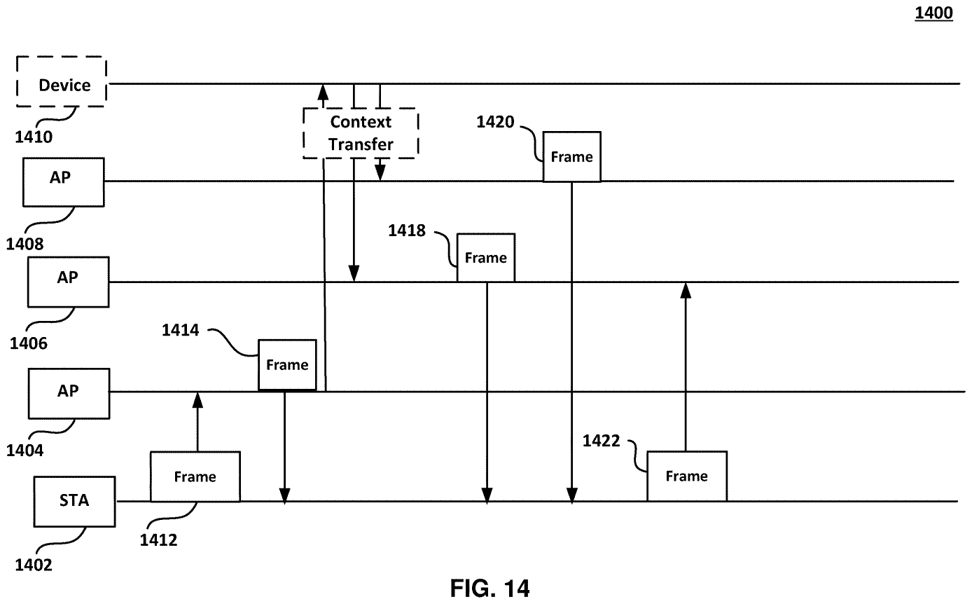

FIG. 14 illustrates an example 1400 of a roaming procedure according to an embodiment. Example 1400 is provided for the purpose of illustration only and is not limiting of embodiments of the present disclosure. As shown in FIG. 14, example 1400 may include a STA 1402, APs 1404, 1406, and 1408, and a device 1410. In an embodiment, each of APs 1404, 1406, and 1408 and STA 1402 may be a multi-link device (MLD), that is a device capable of operating over multiple links as defined by the IEEE 802.11 standard.

Device 1410 may be a controller. Device 1410 may be connected (e.g., through a wired/wireless backhaul) to each of APs 1404, 1406, and 1408. As such, device 1410 may enable communication between APs 1404, 1406, and 1408. For example, device 1410 may enable context transfer between APs 1404, 1406, and 1408 as a STA associated with one of APs 1404, 1406, and 1408 roams/transitions to another one of APs 1404, 1406, and 1408. As such, association and authentication of the STA may not need to be performed again when the STA roams/transitions between APs 1404, 1406, and 1408.

At the beginning of example 1400, STA 1402 may be associated with AP 1404 and may have established a secure session with AP 1404. In an embodiment, STA 1402 may have an established link with AP 1404. In an example, based on determining that a link quality of the established link with AP 1404 is lower than a threshold, STA 1402 may determine to initiate a session transfer from AP 1404. To initiate session transfer from AP 1404 to another AP, STA 1402 may send a frame 1412 to AP 1404. Frame 1412 may indicate a plurality of candidate APs. The plurality of candidate APs may include APs 1406 and 1408. Frame 1412 may comprise a link reconfiguration notify frame, a roaming announcement notify frame, a roaming announcement request frame, a roaming request frame, a roaming notify frame, or a probe request frame.

On receiving frame 1412, AP 1406 may transmit a frame 1414 to STA 1402. Frame 1414 may indicate addition of a plurality of links between STA 1402 and the plurality of candidate APs. For example, frame 1414 may indicate addition of a first link between STA 1402 and AP 1406 and a second link between STA 1402 and AP 1408. In an embodiment, before transmitting frame 1414, AP 1404 may communicate with device 1410 to determine if the session transfer is approved. If device 1410 approves the session transfer, AP 1404 transmits frame 1414 to STA 1402. In an embodiment, if device 1410 approves the session transfer, device 1410 transfers a context related to STA 1402 from AP 1404 to the candidate APs, e.g., AP 1406 and AP 1408. The context related to STA 1402 may include sequence numbers per traffic identifier for STA 1402. Device 1410 may also change a data path for data incoming from upper layers from AP 1404 to AP 1406 and AP 1408. Frame 1414 may comprise a link reconfiguration notify frame, a link reconfiguration response frame, a roaming request frame, or a roaming response frame.

After receiving frame 1414, STA 1402 may start communicating with both AP 1406 and AP 1408. In an embodiment (not shown in FIG. 14), STA 1402 may receive one or more frames 1418 from AP 1406 via the first link and one or more frames 1420 from AP 1408 via the second link. In an embodiment, the one or more frames 1418 and/or the one or more frames 1420 may be addressed to STA 1402. In an embodiment, the one or more frames 1418 and/or the one or more frames 1420 may comprise data frames.

Based on the one or more frames 1418 and the one or more frames 1420, STA 1402 may determine one of APs 1406 and 1408 as an AP with which to maintain a link. In an embodiment, STA 1402 may determine a first link quality for the first link based on the one or more frames 1418 and a second link quality for the second link based on the one or more frames 1420. STA 1402 may determine to maintain a link with AP 1406 or AP 1408 based on the first link quality and the second link quality. In an embodiment, STA 1402 may determine to maintain a link with the AP among APs 1406 and 1408 with the maximum/best link quality among the first link quality and the second link quality. In an embodiment, the link that STA 1402 determines to maintain has a link quality that is better than the link quality of the established link between STA 1402 and AP 1404 and/or that is greater than the threshold (e.g., by a pre-determined margin). In example 1400, STA 1402 may determine to maintain the first link with AP 1406 based on the first link quality being better/higher than the second link quality (and the first link quality being better/higher than the link quality of the established link between STA 1402 and AP 1404 and/or being greater than the threshold (e.g., by a pre-determined margin)). As such, STA 1402 may transmit a frame 1422 requesting maintenance of the first link between STA 1402 and AP 1406. Frame 1422 may comprise a link reconfiguration request frame, or a roaming request frame.

In another embodiment, frame 1414 (or another frame from AP 1404) may comprise/indicate respective beamforming information for each of the plurality of links. For example, frame 1414 may comprise/indicate first beamforming information for the first link between STA 1402 and AP 1406 and second beamforming information for the second link between STA 1402 and AP 1408. The first/second beamforming information may comprise a first/second receive beamforming matrix. In an embodiment, the one or more frames 1418 may be beamformed using the first beamforming information and the one or more frames 1420 may be beamformed using the second beamforming information. In an embodiment, STA 1402 may use the first beamforming information to receive the beamformed one or more frames 1418 and may use the second beamforming information to receive the beamformed one or more frames 1420. STA 1402 may determine the first link quality of the first link based on receiving the beamformed one or more frames 1418 and may determine the second link quality of the second link based on receiving the beamformed one or frames 1420. As such, STA 1402 may determine to maintain a link with one of APs 1406 and 1408 based on which of APs 1406 and 1408 has a better beamformed link with STA 1402.

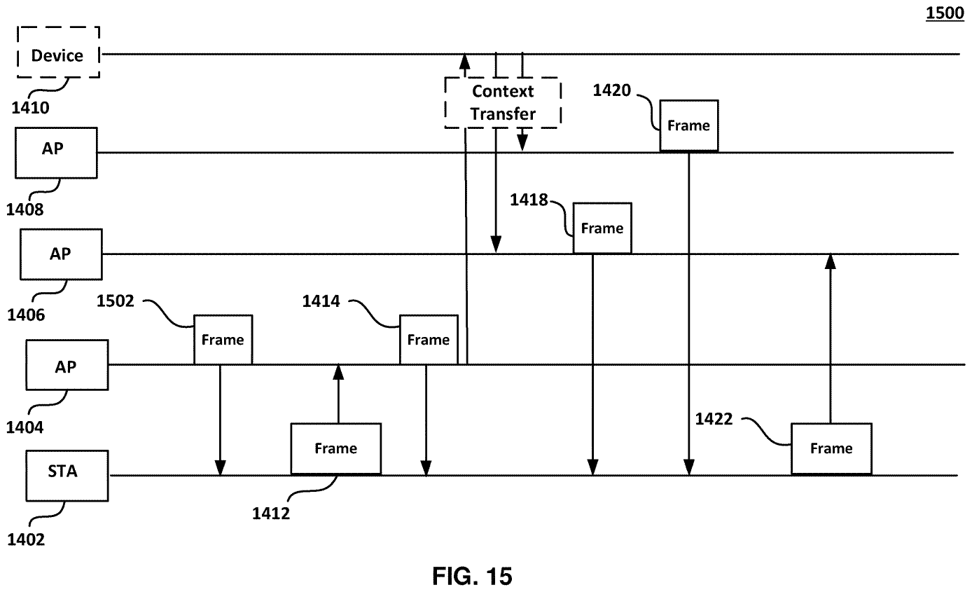

FIG. 15 illustrates an example 1500 of a roaming/transition procedure according to an embodiment. Example 1500 is provided for the purpose of illustration only and is not limiting of embodiments of the present disclosure. As shown in FIG. 15, example 1500 may include a STA 1402, APs 1404, 1406, and 1408, and a device 1410. In an embodiment, each of APs 1404, 1406, and 1408 and STA 1402 may be a multi-link device (MLD), that is a device capable of operating over multiple links as defined by the IEEE 802.11 standard.

Device 1410 may be a controller. Device 1410 may be connected (e.g., through a wired/wireless backhaul) to each of APs 1404, 1406, and 1408. As such, device 1410 may enable communication between APs 1404, 1406, and 1408. For example, device 1410 may enable context transfer between APs 1404, 1406, and 1408 as a STA associated with one of APs 1404, 1406, and 1408 roams/transitions to another one of APs 1404, 1406, and 1408. As such, association and authentication of the STA may not need to be performed again when the STA roams/transitions between APs 1404, 1406, and 1408.

At the beginning of example 1500, STA 1402 may be associated with AP 1404 and may have established a secure session with AP 1404. In an embodiment, STA 1402 may have an established link with AP 1404. In an embodiment, STA 1402 may receive from AP 1404 a frame 1502 indicating a plurality of candidate APs for session transfer. The plurality of candidate APs may be APs in proximity to AP 1404. For example, the plurality of candidate APs may be APs that are part of a same multi-AP group as AP 1404 or part of a same ESS or mobility domain as AP 1404. In an embodiment, AP 1404 may indicate a subset of the APs that are in the same multi-AP group or in the same ESS (or mobility domain) as AP 1404 as the candidate APs. In an embodiment, the candidate APs are recommended by AP 1404. In example 1500, the plurality of candidate APs may include APs 1406 and 1408. Frame 1502 may comprise a beacon frame, an association response frame, a roaming response frame, or a probe response frame. Frame 1502 may be unsolicited or in response to a query frame from STA 1402.

Subsequently, based on determining that a link quality of the established link with AP 1404 is lower than a threshold, STA 1402 may determine to initiate a session transfer from AP 1404. To initiate session transfer from AP 1404 to another AP, STA 1402 may send a frame 1412 to AP 1404. Frame 1412 may indicate the plurality of candidate APs as indicated in frame 1502. The plurality of candidate APs may include APs 1406 and 1408. In another embodiment, one or more of frame 1412 may be transmitted successively, with each frame indicating one of the plurality of candidate APs indicated in frame 1502. Frame 1412 may comprise a link reconfiguration request/notify frame, a roaming announcement notify frame, a roaming announcement request frame, a roaming request frame, a roaming notify frame, or a probe request frame.

On receiving frame 1412, AP 1404 may transmit a frame 1414 to STA 1402. Frame 1414 may indicate addition of a plurality of links between STA 1402 and the plurality of candidate APs. For example, frame 1414 may indicate addition of a first link between STA 1402 and AP 1406 and a second link between STA 1402 and AP 1408. In another embodiment, AP 1404 may transmit one or more frame 1414, with each frame (being in response to a respective frame 1412) indicating addition of a respective link between STA 1402 and a respective AP of the plurality of candidate APs. In an embodiment, before transmitting frame 1414, AP 1404 may communicate with device 1410 to determine if the session transfer (or link addition(s)) is approved/accepted. If AP 1406 and/or device 1410 approves/accepts the session transfer (or link addition), AP 1404 transmits frame 1414 to STA 1402. In an embodiment, if device 1410 approves the session transfer (or link addition), AP 1404 or device 1410 transfers a context related to STA 1402 from AP 1404 to the candidate APs, e.g., AP 1406 and AP 1408. In an embodiment, context related to STA 1402 is transferred from AP 1404 to AP 1406 in response to a frame 1412 indicating AP 1406 and from AP 1404 to AP 1408 in response to a frame 1412 indicating AP 1408. The context related to STA 1402 may include sequence numbers per traffic identifier for STA 1402. Device 1410 may also change a data path for data incoming from upper layers from AP 1404 to AP 1406 and AP 1408. Frame 1414 may comprise a link reconfiguration notify frame, a link reconfiguration response frame, a roaming request frame, or a roaming response frame.

After receiving frame 1414, STA 1402 may start communicating with both AP 1406 and AP 1408. In an embodiment (not shown in FIG. 15), STA 1402 may receive one or more frames 1418 from AP 1406 via the first link and one or more frames 1420 from AP 1408 via the second link. In an embodiment, the one or more frames 1418 and/or the one or more frames 1420 may be addressed to STA 1402. In an embodiment, the one or more frames 1418 and/or the one or more frames 1420 may comprise data frames.

Based on the one or more frames 1418 and the one or more frames 1420, STA 1402 may determine one of APs 1406 and 1408 as an AP with which to maintain a link. In an embodiment, STA 1402 may determine a first link quality for the first link based on the one or more frames 1418 and a second link quality for the second link based on the one or more frames 1420. STA 1402 may determine to maintain a link with AP 1406 or AP 1408 based on the first link quality and the second link quality. In an embodiment, STA 1402 may determine to maintain a link with the AP among APs 1406 and 1408 with the maximum/best link quality among the first link quality and the second link quality. In an embodiment, the link that STA 1402 determines to maintain has a link quality that is better than the link quality of the established link between STA 1402 and AP 1404 and/or that is greater than the threshold (e.g., by a pre-determined margin). In example 1500, STA 1402 may determine to maintain the first link with AP 1406 based on the first link quality being better/higher than the second link quality (and the first link quality being better/higher than the link quality of the established link between STA 1402 and AP 1404 and/or being greater than the threshold (e.g., by a pre-determined margin)). As such, STA 1402 may transmit a frame 1422 requesting maintenance of the first link between STA 1402 and AP 1406. In an embodiment, frame 1422 initiates/executes roaming/transition to AP 1506. Frame 1422 may comprise a link reconfiguration request frame, or a roaming request frame. In an embodiment, AP 1406 responds to frame 1422 indicating completion of the roaming/transition procedure to AP 1406.

In another embodiment, frame 1414 (or another frame from AP 1404) may comprise/indicate respective beamforming information for each of the plurality of links. For example, frame 1414 may comprise/indicate first beamforming information for the first link between STA 1402 and AP 1406 and second beamforming information for the second link between STA 1402 and AP 1408. The first/second beamforming information may comprise a first/second receive beamforming matrix. In an embodiment, the one or more frames 1418 may be beamformed using the first beamforming information and the one or more frames 1420 may be beamformed using the second beamforming information. In an embodiment, STA 1402 may use the first beamforming information to receive the beamformed one or more frames 1418 and may use the second beamforming information to receive the beamformed one or more frames 1420. STA 1402 may determine the first link quality of the first link based on receiving the beamformed one or more frames 1418 and may determine the second link quality of the second link based on receiving the beamformed one or frames 1420. As such, STA 1402 may determine to maintain a link with one of APs 1406 and 1408 based on which of APs 1406 and 1408 has a better beamformed link with STA 1402.

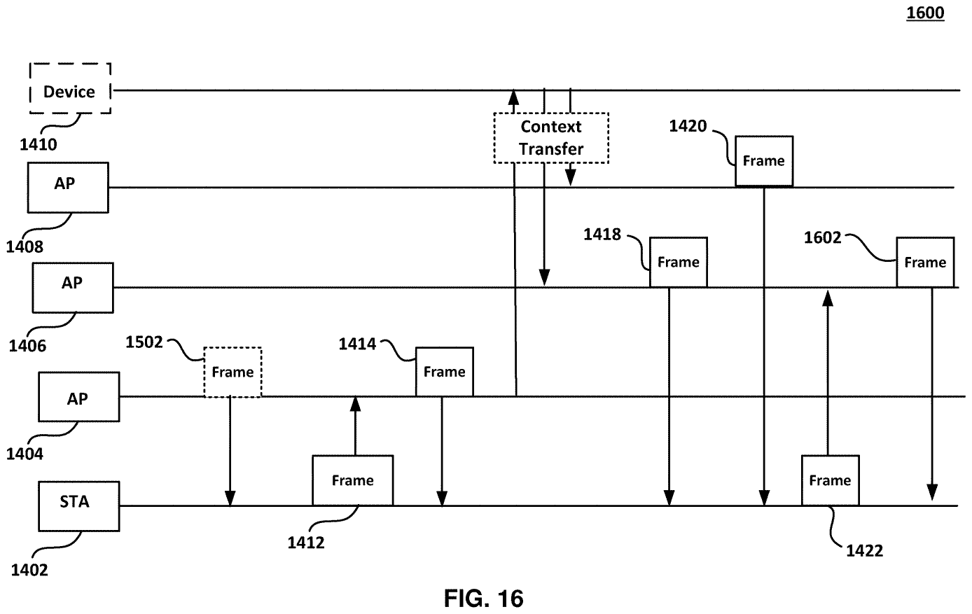

FIG. 16 illustrates an example 1600 of a roaming procedure according to an embodiment. Example 1600 is provided for the purpose of illustration only and is not limiting of embodiments of the present disclosure. As shown in FIG. 16, example 1600 may include a STA 1402, APs 1404, 1406, and 1408, and a device 1410. In an embodiment, each of APs 1404, 1406, and 1408 and STA 1402 may be a multi-link device (MLD), that is a device capable of operating over multiple links as defined by the IEEE 802.11 standard.

Device 1410 may be a controller. Device 1410 may be connected (e.g., through a wired/wireless backhaul) to each of APs 1404, 1406, and 1408. As such, device 1410 may enable communication between APs 1404, 1406, and 1408. For example, device 1410 may enable context transfer between APs 1404, 1406, and 1408 as a STA associated with one of APs 1404, 1406, and 1408 roams/transitions to another one of APs 1404, 1406, and 1408. As such, association and authentication of the STA may not need to be performed again when the STA roams/transitions between APs 1404, 1406, and 1408.

At the beginning of example 1600, STA 1402 may be associated with AP 1404 and may have established a secure session with AP 1404. In an embodiment, STA 1402 may have an established link with AP 1404. In an embodiment, STA 1402 may receive from AP 1404 frame 1502 as described above in FIG. 15. In another embodiment, STA 1402 may not receive frame 1502 from AP 1404.

In an example, based on determining that a link quality of the established link with AP 1404 is lower than a threshold, STA 1402 may determine to initiate a session transfer from AP 1404. To initiate session transfer from AP 1404 to another AP, STA 1402 may send a frame 1412 to AP 1404. Frame 1412 may indicate a plurality of candidate APs. The plurality of candidate APs may include APs 1406 and 1408. Frame 1412 may comprise a link reconfiguration notify frame, a roaming announcement notify frame, a roaming announcement request frame, a roaming request frame, a roaming notify frame, or a probe request frame STA 1402 may determine to initiate a session transfer from AP 1404. To initiate session transfer from AP 1404 to another AP, STA 1402 may send a frame 1412 to AP 1404. Frame 1412 may indicate a plurality of candidate APs. The plurality of candidate APs may include APs 1406 and 1408. Frame 1412 may comprise a link reconfiguration notify frame, a roaming announcement notify frame, a roaming announcement request frame, a roaming request frame, a roaming notify frame, or a probe request frame.

On receiving frame 1412, AP 1406 may transmit a frame 1414 to STA 1402. Frame 1414 may indicate addition of a plurality of links between STA 1402 and the plurality of candidate APs. For example, frame 1414 may indicate addition of a first link between STA 1402 and AP 1406 and a second link between STA 1402 and AP 1408. In an embodiment, before transmitting frame 1414, AP 1404 may communicate with device 1410 to determine if the session transfer is approved. If device 1410 approves the session transfer, AP 1404 transmits frame 1414 to STA 1402. In an embodiment, if device 1410 approves the session transfer, device 1410 transfers a context related to STA 1402 from AP 1404 to the candidate APs, e.g., AP 1406 and AP 1408. The context related to STA 1402 may include sequence numbers per traffic identifier for STA 1402. Device 1410 may also change a data path for data incoming from upper layers from AP 1404 to AP 1406 and AP 1408. Frame 1414 may comprise a link reconfiguration notify frame, a link reconfiguration response frame, a roaming request frame, or a roaming response frame.

After receiving frame 1414, STA 1402 may start communicating with both AP 1406 and AP 1408. In an embodiment (not shown in FIG. 16), STA 1402 may receive one or more frames 1418 from AP 1406 via the first link and one or more frames 1420 from AP 1408 via the second link. In an embodiment, the one or more frames 1418 and/or the one or more frames 1420 may be addressed to STA 1402. In an embodiment, the one or more frames 1418 and/or the one or more frames 1420 may comprise data frames.

Based on the one or more frames 1418 and the one or more frames 1420, STA 1402 may determine one of APs 1406 and 1408 as an AP with which to maintain a link. In an embodiment, STA 1402 may determine a first link quality for the first link based on the one or more frames 1418 and a second link quality for the second link based on the one or more frames 1420. STA 1402 may determine to maintain a link with AP 1406 or AP 1408 based on the first link quality and the second link quality. In an embodiment, STA 1402 may determine to maintain a link with the AP among APs 1406 and 1408 with the maximum/best link quality among the first link quality and the second link quality. In an embodiment, the link that STA 1402 determines to maintain has a link quality that is better than the link quality of the established link between STA 1402 and AP 1404 and/or that is greater than the threshold (e.g., by a pre-determined margin). In example 1600, STA 1402 may determine to maintain the first link with AP 1406 based on the first link quality being better/higher than the second link quality (and the first link quality being better/higher than the link quality of the established link between STA 1402 and AP 1404 and/or being greater than the threshold (e.g., by a pre-determined margin)). As such, STA 1402 may transmit a frame 1422 requesting maintenance of the first link between STA 1402 and AP 1406. Frame 1422 may comprise a link reconfiguration request frame, or a roaming request frame.

In another embodiment, frame 1414 (or another frame from AP 1404) may comprise/indicate respective beamforming information for each of the plurality of links. For example, frame 1414 may comprise/indicate first beamforming information for the first link between STA 1402 and AP 1406 and second beamforming information for the second link between STA 1402 and AP 1408. The first/second beamforming information may comprise a first/second receive beamforming matrix. In an embodiment, the one or more frames 1418 may be beamformed using the first beamforming information and the one or more frames 1420 may be beamformed using the second beamforming information. In an embodiment, STA 1402 may use the first beamforming information to receive the beamformed one or more frames 1418 and may use the second beamforming information to receive the beamformed one or more frames 1420. STA 1402 may determine the first link quality of the first link based on receiving the beamformed one or more frames 1418 and may determine the second link quality of the second link based on receiving the beamformed one or frames 1420. As such, STA 1402 may determine to maintain a link with one of APs 1406 and 1408 based on which of APs 1406 and 1408 has a better beamformed link with STA 1402.

Returning to FIG. 16, in an embodiment, on receiving frame 1422 from STA 1402, AP 1406 may transmit a frame 1602 to STA 1402. Frame 1602 may indicate deletion of one or more links of the plurality of links added by frame 1414. In an embodiment, the one or more deleted links may include all of the plurality of links except for the first link added between STA 1402 and AP 1406. In another embodiment, the one or more deleted links may include all of the plurality of links except for the first link added between STA 1402 and AP 1406 and another link between STA 1402 and an AP where the other link is associated with a second-best link quality. In another embodiment, frame 1602 may further indicate deletion of the established link between STA 1402 and AP 1404.

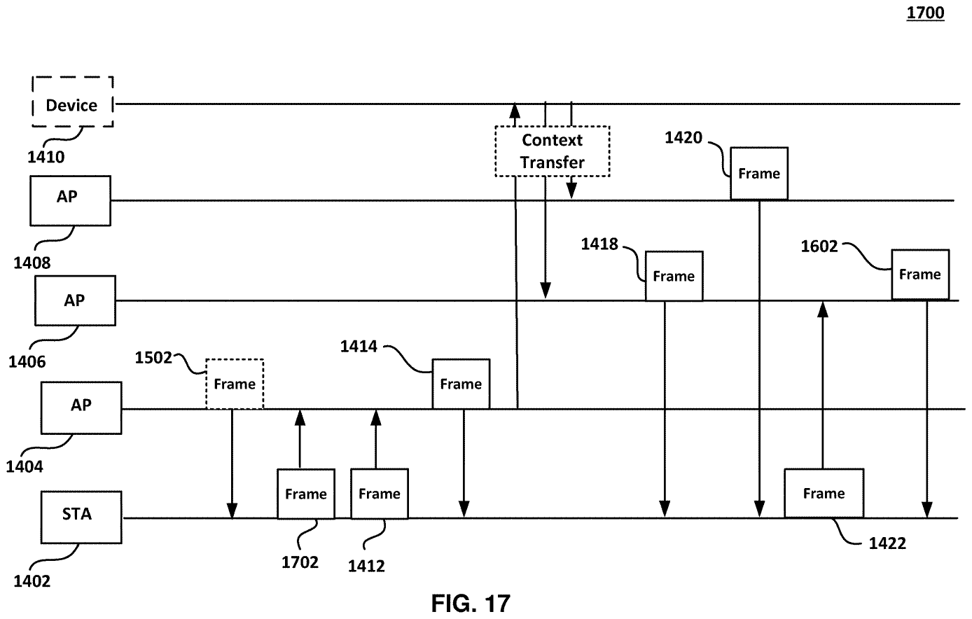

FIG. 17 illustrates an example 1700 of a roaming procedure according to an embodiment. Example 1700 is provided for the purpose of illustration only and is not limiting of embodiments of the present disclosure. As shown in FIG. 17, example 1700 may include a STA 1402, APs 1404, 1406, and 1408, and a device 1410. In an embodiment, each of APs 1404, 1406, and 1408 and STA 1402 may be a multi-link device (MLD), that is a device capable of operating over multiple links as defined by the IEEE 802.11 standard.

Device 1410 may be a controller. Device 1410 may be connected (e.g., through a wired/wireless backhaul) to each of APs 1404, 1406, and 1408. As such, device 1410 may enable communication between APs 1404, 1406, and 1408. For example, device 1410 may enable context transfer between APs 1404, 1406, and 1408 as a STA associated with one of APs 1404, 1406, and 1408 roams/transitions to another one of APs 1404, 1406, and 1408. As such, association and authentication of the STA may not need to be performed again when the STA roams/transitions between APs 1404, 1406, and 1408.

At the beginning of example 1700, STA 1402 may be associated with AP 1404 and may have established a secure session with AP 1404. In an embodiment, STA 1402 may have an established link with AP 1404. In an embodiment, STA 1402 may receive from AP 1404 frame 1502 as described above in FIG. 15. Frame 1502 may indicate a plurality of candidate APs. In response to frame 1502, STA 1402 may transmit a frame 1702 requesting addition of a plurality of links between STA 1402 and the plurality of candidate APs. In another embodiment, STA 1402 may determine a subset of the plurality of candidate APs indicated in frame 1502, where the subset represents APs from which STA 1402 can receive/hear frames. STA 1402 may request in frame 1702 addition of links between STA 1402 and the determined subset of the plurality of candidate APs. In another embodiment, STA 1402 may not receive frame 1502 from AP 1404. In this embodiment, STA 1402 may determine itself the plurality of candidate APs and may request addition of the plurality of links between STA 1402 and the plurality of candidate APs in frame 1702. For example, STA 1402 may determine the plurality of candidate APs as those APs from which it is able to receive/hear frames.

Subsequently, based on determining that a link quality of the established link with AP 1404 is lower than a threshold, STA 1402 may determine to initiate a session transfer from AP 1404. To initiate session transfer from AP 1404 to another AP, STA 1402 may send a frame 1412 to AP 1404. Frame 1412 may indicate the plurality of candidate APs. The plurality of candidate APs may include APs 1406 and 1408. Frame 1412 may comprise a link reconfiguration notify frame, a roaming announcement notify frame, a roaming announcement request frame, a roaming request frame, a roaming notify frame, or a probe request frame. In another embodiment, in addition to indicating the plurality of candidate APs, frame 1412 may comprise a request to add the plurality of links between STA 1402 and the plurality of candidate APs. In such an embodiment, STA 1402 may not transmit frame 1702 or may aggregate frame 1702 with frame 1412.

On receiving frame 1412, AP 1406 may transmit a frame 1414 to STA 1402. Frame 1414 may indicate addition of a plurality of links between STA 1402 and the plurality of candidate APs. For example, frame 1414 may indicate addition of a first link between STA 1402 and AP 1406 and a second link between STA 1402 and AP 1408. In an embodiment, before transmitting frame 1414, AP 1404 may communicate with device 1410 to determine if the session transfer is approved. If device 1410 approves the session transfer, AP 1404 transmits frame 1414 to STA 1402. In an embodiment, if device 1410 approves the session transfer, device 1410 transfers a context related to STA 1402 from AP 1404 to the candidate APs, e.g., AP 1406 and AP 1408. The context related to STA 1402 may include sequence numbers per traffic identifier for STA 1402. Device 1410 may also change a data path for data incoming from upper layers from AP 1404 to AP 1406 and AP 1408. Frame 1414 may comprise a link reconfiguration notify frame, a link reconfiguration response frame, a roaming request frame, or a roaming response frame.

STA 1402 may start communicating with both AP 1406 and AP 1408. In an embodiment (not shown in FIG. 17), STA 1402 may receive one or more frames 1418 from AP 1406 via the first link and one or more frames 1420 from AP 1408 via the second link. In an embodiment, the one or more frames 1418 and/or the one or more frames 1420 may be addressed to STA 1402. In an embodiment, the one or more frames 1418 and/or the one or more frames 1420 may comprise data frames.

Based on the one or more frames 1418 and the one or more frames 1420, STA 1402 may determine one of APs 1406 and 1408 as an AP with which to maintain a link. In an embodiment, STA 1402 may determine a first link quality for the first link based on the one or more frames 1418 and a second link quality for the second link based on the one or more frames 1420. STA 1402 may determine to maintain a link with AP 1406 or AP 1408 based on the first link quality and the second link quality. In an embodiment, STA 1402 may determine to maintain a link with the AP among APs 1406 and 1408 with the maximum/best link quality among the first link quality and the second link quality. In an embodiment, the link that STA 1402 determines to maintain has a link quality that is better than the link quality of the established link between STA 1402 and AP 1404 and/or that is greater than the threshold (e.g., by a pre-determined margin). In example 1700, STA 1402 may determine to maintain the first link with AP 1406 based on the first link quality being better/higher than the second link quality (and the first link quality being better/higher than the link quality of the established link between STA 1402 and AP 1404 and/or being greater than the threshold (e.g., by a pre-determined margin)). As such, STA 1402 may transmit a frame 1422 requesting maintenance of the first link between STA 1402 and AP 1406. Frame 1422 may comprise a link reconfiguration request frame, or a roaming request frame.

In another embodiment, frame 1414 (or another frame from AP 1404) may comprise/indicate respective beamforming information for each of the plurality of links. For example, frame 1414 may comprise/indicate first beamforming information for the first link between STA 1402 and AP 1406 and second beamforming information for the second link between STA 1402 and AP 1408. The first/second beamforming information may comprise a first/second receive beamforming matrix. In an embodiment, the one or more frames 1418 may be beamformed using the first beamforming information and the one or more frames 1420 may be beamformed using the second beamforming information. In an embodiment, STA 1402 may use the first beamforming information to receive the beamformed one or more frames 1418 and may use the second beamforming information to receive the beamformed one or more frames 1420. STA 1402 may determine the first link quality of the first link based on receiving the beamformed one or more frames 1418 and may determine the second link quality of the second link based on receiving the beamformed one or frames 1420. As such, STA 1402 may determine to maintain a link with one of APs 1406 and 1408 based on which of APs 1406 and 1408 has a better beamformed link with STA 1402.

Returning to FIG. 17, in an embodiment, on receiving frame 1422 from STA 1402, AP 1406 may transmit a frame 1602 to STA 1402. Frame 1602 may indicate deletion of one or more links of the plurality of links added by frame 1414. In an embodiment, the one or more deleted links may include all of the plurality of links except for the first link added between STA 1402 and AP 1406. In another embodiment, the one or more deleted links may include all of the plurality of links except for the first link added between STA 1402 and AP 1406 and another link between STA 1402 and an AP where the other link is associated with a second-best link quality. In another embodiment, frame 1602 may further indicate deletion of the established link between STA 1402 and AP 1404.

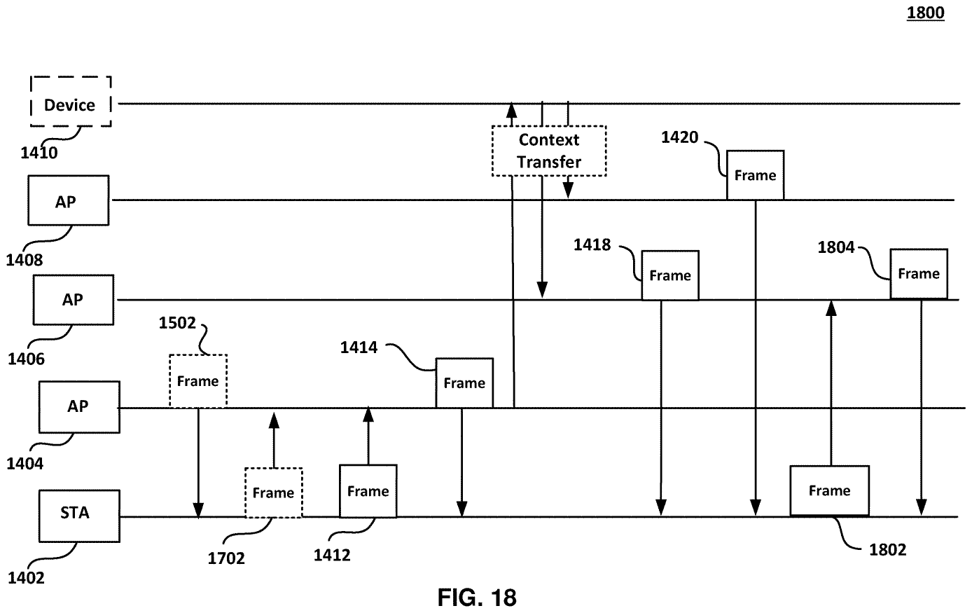

FIG. 18 illustrates an example 1800 of a roaming procedure according to an embodiment. Example 1800 is provided for the purpose of illustration only and is not limiting of embodiments of the present disclosure. As shown in FIG. 18, example 1800 may include a STA 1402, APs 1404, 1406, and 1408, and a device 1410. In an embodiment, each of APs 1404, 1406, and 1408 and STA 1402 may be a multi-link device (MLD), that is a device capable of operating over multiple links as defined by the IEEE 802.11 standard.

Device 1410 may be a controller. Device 1410 may be connected (e.g., through a wired/wireless backhaul) to each of APs 1404, 1406, and 1408. As such, device 1410 may enable communication between APs 1404, 1406, and 1408. For example, device 1410 may enable context transfer between APs 1404, 1406, and 1408 as a STA associated with one of APs 1404, 1406, and 1408 roams/transitions to another one of APs 1404, 1406, and 1408. As such, association and authentication of the STA may not need to be performed again when the STA roams/transitions between APs 1404, 1406, and 1408.

At the beginning of example 1800, STA 1402 may be associated with AP 1404 and may have established a secure session with AP 1404. In an embodiment, STA 1402 may have an established link with AP 1404. In an embodiment, STA 1402 may receive from AP 1404 frame 1502 as described above in FIG. 15. Frame 1502 may indicate a plurality of candidate APs. In response to frame 1502, STA 1402 may transmit a frame 1702, as described in FIG. 17, requesting addition of a plurality of links between STA 1402 and the plurality of candidate APs. In another embodiment, STA 1402 may determine a subset of the plurality of candidate APs indicated in frame 1502, where the subset represents APs from which STA 1402 can receive/hear frames. STA 1402 may request in frame 1702 addition of links between STA 1402 and the determined subset of the plurality of candidate APs. In another embodiment, STA 1402 may not receive frame 1502 from AP 1404. In this embodiment, STA 1402 may determine itself the plurality of candidate APs and may request addition of the plurality of links between STA 1402 and the plurality of candidate APs in frame 1702. For example, STA 1402 may determine the plurality of candidate APs as those APs from which it is able to receive/hear frames.

Based on determining that a link quality of the established link with AP 1404 is lower than a threshold, STA 1402 may determine to initiate a session transfer from AP 1404. STA 1402 may determine to initiate a session transfer from AP 1404. To initiate session transfer from AP 1404 to another AP, STA 1402 may send a frame 1412 to AP 1404. Frame 1412 may indicate a plurality of candidate APs. The plurality of candidate APs may include APs 1406 and 1408. Frame 1412 may comprise a link reconfiguration notify frame, a roaming announcement notify frame, a roaming announcement request frame, a roaming request frame, a roaming notify frame, or a probe request frame.

On receiving frame 1412, AP 1406 may transmit a frame 1414 to STA 1402. Frame 1414 may indicate addition of a plurality of links between STA 1402 and the plurality of candidate APs. For example, frame 1414 may indicate addition of a first link between STA 1402 and AP 1406 and a second link between STA 1402 and AP 1408. In an embodiment, before transmitting frame 1414, AP 1404 may communicate with device 1410 to determine if the session transfer is approved. If device 1410 approves the session transfer, AP 1404 transmits frame 1414 to STA 1402. In an embodiment, if device 1410 approves the session transfer, device 1410 transfers a context related to STA 1402 from AP 1404 to the candidate APs, e.g., AP 1406 and AP 1408. The context related to STA 1402 may include sequence numbers per traffic identifier for STA 1402. Device 1410 may also change a data path for data incoming from upper layers from AP 1404 to AP 1406 and AP 1408. Frame 1414 may comprise a link reconfiguration notify frame, a link reconfiguration response frame, a roaming request frame, or a roaming response frame.

STA 1402 may start communicating with both AP 1406 and AP 1408. In an embodiment (not shown in FIG. 18), STA 1402 may receive one or more frames 1418 from AP 1406 via the first link and one or more frames 1420 from AP 1408 via the second link. In an embodiment, the one or more frames 1418 and/or the one or more frames 1420 may be addressed to STA 1402. In an embodiment, the one or more frames 1418 and/or the one or more frames 1420 may comprise data frames.

Based on the one or more frames 1418 and the one or more frames 1420, STA 1402 may determine a first link quality for the first link based on the one or more frames 1418 and a second link quality for the second link based on the one or more frames 1420. STA 1402 may transmit a frame 1802 comprising/indicating the first link quality and the second link quality. STA 1402 may transmit frame 1802 to any of APs 1404, 1406, and 1408. In an embodiment, the AP that receives frame 1802 may forward frame 1802 (or the contents thereof) to device 1410. Based on frame 1802 (or the contents thereof), device 1410 may determine to maintain one or more links between STA 1402 and APs 1406 and 1408. In example 1800, device 1410 may determine to maintain the first link with AP 1406 based on the first link quality being better/higher than the second link quality. As such, device 1410 may transmit a frame 1804 via e.g., AP 1406 to STA 1402 requesting maintenance of the first link between STA 1402 and AP 1406. Frame 1804 may comprise a link reconfiguration request frame, or a roaming request frame.

In another embodiment, frame 1414 (or another frame from AP 1404) may comprise/indicate respective beamforming information for each of the plurality of links. For example, frame 1414 may comprise/indicate first beamforming information for the first link between STA 1402 and AP 1406 and second beamforming information for the second link between STA 1402 and AP 1408. The first/second beamforming information may comprise a first/second receive beamforming matrix. In an embodiment, the one or more frames 1418 may be beamformed using the first beamforming information and the one or more frames 1420 may be beamformed using the second beamforming information. In an embodiment, STA 1402 may use the first beamforming information to receive the beamformed one or more frames 1418 and may use the second beamforming information to receive the beamformed one or more frames 1420. STA 1402 may determine the first link quality of the first link based on receiving the beamformed one or more frames 1418 and may determine the second link quality of the second link based on receiving the beamformed one or frames 1420. Similar to the embodiment described above, STA 1402 may then transmit frame 1802 to any of APs 1404, 1406, and 1408 comprising/indicating the first link quality and the second link quality. Based on frame 1802, device 1410 may transmit frame 1804 via e.g., AP 1406 to STA 1402 requesting maintenance of the first link between STA 1402 and AP 1406.

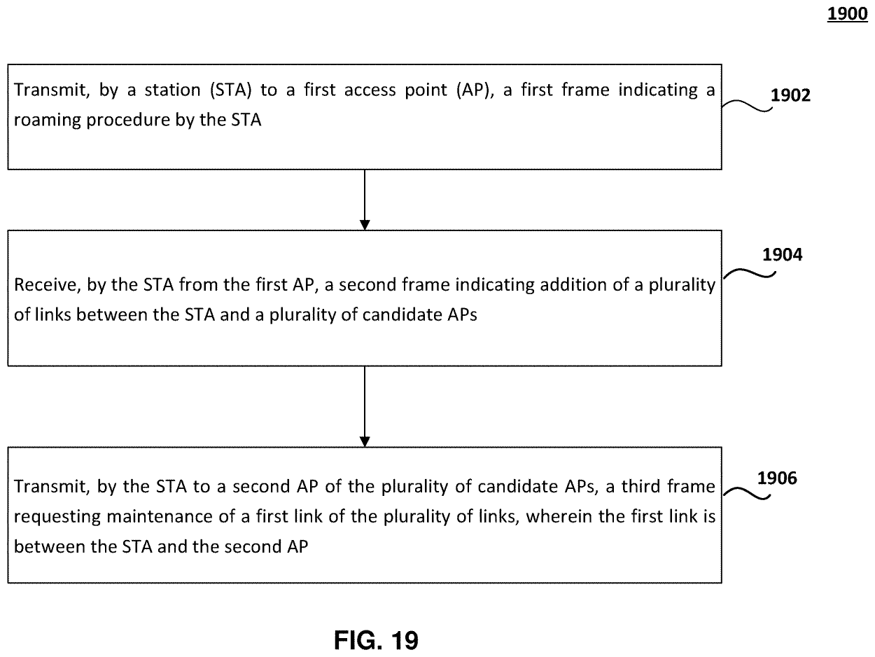

FIG. 19 illustrates an example process 1900 according to an embodiment. Example process 1900 is provided for the purpose of illustration only and is not limiting embodiments. Process 1900 may be performed by a STA, such as STA 1402. The STA may comprise a non-AP MLD. The STA may be capable of operating over a plurality of links, including a first link and a second link. As shown in FIG. 19, process 1900 includes steps 1902, 1904, and 1906.

Step 1902 includes transmitting, by the STA to a first access point (AP), a first frame indicating a roaming procedure by the STA. In an embodiment, the STA may be associated with the first AP. In an embodiment, the first frame may indicate a plurality of candidate APs. In an embodiment, the first frame comprises a link reconfiguration notify frame, a roaming announcement notify frame, a roaming announcement request frame, a roaming request frame, or a roaming notify frame or a probe request frame.

Step 1904 includes receiving, by the STA from the first AP, a second frame indicating addition of a plurality of links between the STA and the plurality of candidate APs. The second frame may comprise a link reconfiguration notify frame, a link reconfiguration response frame, a roaming request frame, or a roaming response frame.

In an embodiment, process 1900 may further comprise receiving, by the STA from the first AP, a fourth frame indicating the plurality of candidate APs. The fourth frame may be received before step 1902. The fourth frame may comprise a beacon frame, an association response frame, a roaming response frame, or a probe response frame.

In an embodiment, process 1900 may further comprise transmitting, by the STA to the first AP, a sixth frame requesting addition of the plurality of links between the STA and the plurality of candidate APs. In an embodiment, the sixth frame may be the same as the first frame or may be aggregated with the first frame.

Step 1906 includes transmitting, by the STA to a second AP of the plurality of candidate APs, a third frame requesting maintenance of a first link of the plurality of links. The first link may be between the STA and the second AP. In an embodiment, the third frame comprises a link reconfiguration request frame or a roaming request frame.

In an embodiment, process 1900 may further comprise receiving, by the STA from the plurality of candidate APs, a respective plurality of frames via the plurality of links respectively. The respective plurality of frames may be addressed to the STA. The respective plurality of frames may comprise a plurality of data frames.

In an embodiment, process 1900 may further comprise determining, by the STA, the second AP from the plurality of candidate APs based on the respective plurality of frames. In an embodiment, the determining of the second AP comprises determining a respective link quality for each link of the plurality of links based on a corresponding frame of the respective plurality of frames. In an embodiment, a first link quality of the first link between the STA and the second AP corresponds to a maximum/best link quality among respective link qualities of the plurality of links.

In another embodiment, the second frame (or another frame) may comprise/indicate respective beamforming information for each of the plurality of links. In an embodiment, the beamforming information may comprise/indicate a receive beamforming matrix.

In another embodiment, the second frame may comprise/indicate respective beamforming information for each of the plurality of links, and each frame of the respective plurality of frames is beamformed using the respective beamforming information associated with a respective link of the plurality of links. In an embodiment, the receiving of the respective plurality of frames via the plurality of links may comprise receiving each frame of the respective plurality of frames using the respective beamforming information associated with the respective link of the plurality of links.

In an embodiment, process 1900 may further comprise receiving, by the STA from the second AP (or the first AP), a frame indicating deletion of one or more links of the plurality of links. In an embodiment, the one or more links do not comprise the first link. In an embodiment, the frame may indicate deletion of an established link between the STA and the first AP.

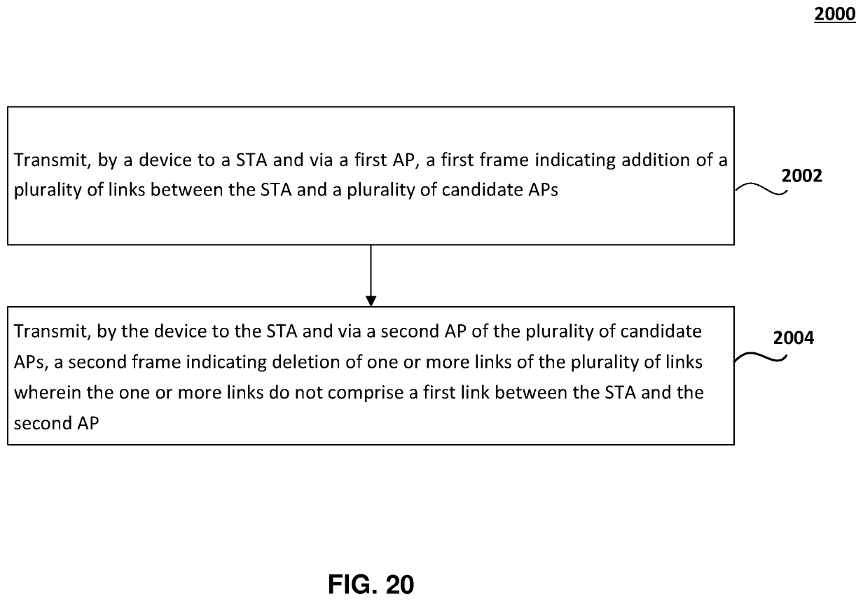

FIG. 20 illustrates an example process 20000 according to an embodiment. Example process 2000 is provided for the purpose of illustration only and is not limiting embodiments. Process 2000 may be performed by a device, such as device 1410. The device may comprise a controller AP. As shown in FIG. 20, process 2000 may comprise steps 2002 and 2004.

Step 2002 includes transmitting, by the device to a STA and via a first AP, a first frame indicating addition of a plurality of links between the STA and a plurality of candidate APs. The STA may comprise a non-AP MLD. The STA may be capable of operating over a plurality of links, including a first link and a second link. The STA may be associated with the first AP. The first frame may comprise a link reconfiguration notify frame, a link reconfiguration response frame, a roaming request frame, or a roaming response frame.

In an embodiment, process 2000 may further comprise receiving, by the device from the STA and via the first AP, a third frame indicating a roaming procedure by the STA. In an embodiment, the transmitting of the first frame may be in response to receiving the third frame. In an embodiment, the third frame may indicate the plurality of candidate APs. In an embodiment, the third frame may comprise a link reconfiguration request frame or a roaming request frame.

In an embodiment, process 2000 may further comprise transmitting, by the device to the STA and via the first AP, a fourth frame indicating the plurality of candidate APs. The fourth frame may comprise a beacon frame, an association response frame, a roaming response frame, or a probe response frame.

In an embodiment, process 2000 may further comprise receiving, by the device from the STA and via the first AP, a fifth frame requesting addition of the plurality of links between the STA and the plurality of candidate APs.

Step 2004 comprises transmitting, by the device to the STA and via a second AP of the plurality of candidate APs, a second frame indicating deletion of one or more links of the plurality of links. In an embodiment, the one or more links do not comprise a first link between the STA and the second AP. The second frame may comprise a link reconfiguration notify frame, a roaming announcement notify frame, a roaming announcement request frame, or a link reconfiguration response frame.

In an embodiment, process 2000 may further comprise determining, by the device, the second AP, from the plurality of candidate APs, based on one or more sixth frames received from the STA. In an embodiment, the one or more sixth frames may comprise/indicate a respective link quality for each link of the plurality of links.

In an embodiment, the plurality of candidate APs may transmit to the STA a plurality of respective frames via the plurality of links. The plurality of respective frames may be addressed to the STA. In an embodiment the plurality of respective frames may comprise respective data frames. In an embodiment, the STA may measure/compute the respective link quality for each link of the plurality of links based on a respective seventh frame received by the STA from a respective AP of the plurality of candidate APs via that each link. In an embodiment, a first link quality of the first link between the STA and the second AP corresponds to a maximum/best link quality among respective link qualities of the plurality of links.

In another embodiment, the first frame (or another frame) may comprise/indicate respective beamforming information for each of the plurality of links. The beamforming information may comprise/indicate a receive beamforming matrix. In an embodiment, each of the plurality of respective frames may be beamformed using respective beamforming information associated with a respective link of the plurality of links. In an embodiment, the STA may receive each of the plurality of respective frames using the respective beamforming information associated with the respective link of the plurality of links.

What is claimed is:

1. A station (STA) multi-link device (MLD), comprising:
one or more processors; and
memory storing instructions that, when executed by the one or more processors, cause the STA MLD to:
receive, from a first access point (AP) MLD with which the STA MLD is associated, a first frame indicating a plurality of candidate target AP MLDs for a transition by the STA MLD;
transmit, to the first AP MLD, one or more first link reconfiguration request frames indicating one or more second AP MLDs from the plurality of candidate target AP MLDs and requesting addition of one or more links between the STA MLD and the one or more second AP MLDs;
receive, from the first AP MLD, one or more link reconfiguration response frames indicating addition of the one or more links between the STA MLD and the one or more second AP MLDs; and
transmit, to a third AP MLD of the one or more second AP MLDs, a second link reconfiguration request frame requesting transitioning to the third AP MLD.

2. The STA MLD of claim 1, wherein the instructions, when executed by the one or more processors, further cause the STA MLD to transmit to the first AP MLD a second frame requesting a recommendation of candidate target AP MLDs.

3. The STA MLD of claim 1, wherein the plurality of candidate target AP MLDs are part of a same mobility domain as the first AP MLD.

4. The STA MLD of claim 1, wherein the instructions, when executed by the one or more processors, further cause the STA MLD to receive one or more frames from at least one of the one or more second AP MLDs.

5. The STA MLD of claim 4, wherein the instructions, when executed by the one or more processors, further cause the STA MLD to determine a link quality for at least one of the one or more links.

6. The STA MLD of claim 1, wherein the second link reconfiguration request frame executes the transitioning to the third AP MLD.

7. The STA MLD of claim 1, wherein the first frame comprises a neighbor report element, and wherein the neighbor report element indicates capabilities of each of the plurality of candidate target AP MLDs.

8. The STA MLD of claim 1, wherein the one or more first link reconfiguration request frames indicate identifiers of streams of the STA MLD.

9. An access point (AP) multi-link device (MLD), comprising:
one or more processors; and
memory storing instructions that, when executed by the one or more processors, cause the AP MLD to:
transmit, to a station (STA) MLD, a first frame indicating a plurality of candidate target AP MLDs for a transition by the STA MLD;
receive, from the STA MLD, one or more first link reconfiguration request frames indicating one or more second AP MLDs from the plurality of candidate target AP MLDs and requesting addition of one or more links between the STA MLD and the one or more second AP MLDs; and
based on acceptance of addition of the one or more links by the one or more second AP MLDs,
transmit, to the STA MLD, one or more link reconfiguration response frames indicating the addition of one or more links between the STA MLD and the one or more second AP MLDs; and
transfer, to the one or more second AP MLDs, context related to the STA MLD.

10. The AP MLD of claim 9, wherein the instructions, when executed by the one or more processors, further cause the AP MLD to receive, from the STA MLD, a second frame requesting a recommendation of candidate target AP MLDs.

11. The AP MLD of claim 9, wherein the instructions, when executed by the one or more processors, further cause the AP MLD to receive, from the STA MLD, a second link reconfiguration request frame requesting transitioning to a third AP MLD of the one or more second AP MLDs.

12. The AP MLD of claim 11, wherein the second link reconfiguration request frame executes the transitioning to the third AP MLD.

13. The AP MLD of claim 9, wherein the plurality of candidate target AP MLDs are part of a same mobility domain as the first AP MLD.

14. The AP MLD of claim 9, wherein the STA MLD is associated with the AP MLD.

15. The AP MLD of claim 9, wherein the context related to the STA MLD comprises sequence numbers per traffic identifier for the STA MLD.

16. The AP MLD of claim 9, wherein the first frame comprises a neighbor report element, and wherein the neighbor report element indicates capabilities of each of the plurality of candidate target AP MLDs.

17. The AP MLD of claim 9, wherein the one or more first link reconfiguration request frames indicate identifiers of streams of the STA MLD.

18. A non-transitory computer readable medium comprising instructions that, when executed by one or
more processors of a station (STA) multi-link device (MLD), cause the STA MLD to:
receive, from a first access point (AP) MLD with which the STA MLD is associated, a first frame indicating a plurality of candidate target AP MLDs for a transition by the STA MLD;
transmit, to the first AP MLD, one or more first link reconfiguration request frames indicating one or more second AP MLDs from the plurality of candidate target AP MLDs and requesting addition of one or more links between the STA MLD and the one or more second AP MLDs;
receive, from the first AP MLD, one or more link reconfiguration response frames indicating addition of the one or more links between the STA MLD and the one or more second AP MLDs; and
transmit, to a third AP MLD of the one or more second AP MLDs, a second link reconfiguration request frame requesting transitioning to the third AP MLD.

19. The non-transitory computer readable medium of claim 18, wherein the instructions, when executed by the one or more processors, further cause the STA MLD to transmit to the first AP MLD a second frame requesting a recommendation of candidate target AP MLDs.

20. The non-transitory computer readable medium of claim 18, wherein the first frame comprises a neighbor report element, and wherein the neighbor report element indicates capabilities of each of the plurality of candidate target AP MLDs.
